(19) United States
(12) Patent Application Publication
(10) Pub. No.: US 2025/0168782 A1
(43) Pub. Date: May 22, 2025

(54) POWER CONTROL METHOD, AND DEVICE

(71) Applicant: GUANGDONG OPPO MOBILE TELECOMMUNICATIONS CORP., LTD., Dongguan (CN)

(72) Inventors: Yi DING, Dongguan (CN); Shichang ZHANG, Dongguan (CN)

(21) Appl. No.: 19/024,098

(22) Filed: Jan. 16, 2025

Related U.S. Application Data
(63) Continuation of application No. PCT/CN2022/109692, filed on Aug. 2, 2022.

(51) Int. Cl. H04W 52/32; H04W 24/08; H04W 52/24; H04W 92/18

(52) U.S. Cl. CPC H04W 52/325; H04W 24/08; H04W 52/242; H04W 92/18

(57) ABSTRACT

Provided is a method for controlling power. The method is applicable to a first terminal, and the method includes: performing power control on a first signal based on a sidelink path loss and/or a target communication distance, wherein the first signal comprises a positioning reference signal, and the sidelink path loss refers to a transmission loss on a sidelink between the first terminal and a second terminal.

### CROSS-REFERENCE TO RELATED APPLICATION

This application is a continuation application of international application No. PCT/CN2022/109692, filed on Aug. 2, 2022, the entire contents of which are incorporated herein by reference.

### TECHNICAL FIELD

Embodiments of the present disclosure relate to the technical field of communications, and in particular, relate to a method and an apparatus for controlling power, a method and an apparatus for muting transmission, and a device and a storage medium thereof.

### RELATED ART

In sidelink (SL) communication, a target SL user equipment (UE) may be positioned using algorithms based on a road side unit (RSU) or an anchor SL UE, and the terminal device needs to acquire measurement quantities required by the algorithms. Therefore, a positioning reference signal (PRS) also needs to be transmitted between SL UEs and measurements need to be performed based on the PRS. How to adopt a proper method for the SL UE to transmit the PRS requires further research.

### SUMMARY

Embodiments of the present disclosure provide a method and an apparatus for controlling power, a method and an apparatus for muting transmission, and a device and a storage medium. The technical solutions are as follows.

According to some embodiments of the present disclosure, a method for controlling power is provided. The method is applicable to a first terminal, and the method includes:

performing power control on a first signal based on a sidelink path loss and/or a target communication distance, wherein the first signal includes a positioning reference signal, and the sidelink path loss refers to a transmission loss on a sidelink between the first terminal and a second terminal.

According to some embodiments of the present disclosure, a terminal device is provided. The terminal device includes a processor and a memory storing one or more computer programs therein, wherein the processor is configured to load and run the one or more computer programs, to cause the terminal device to perform the method for controlling power or the method for muting transmission described above.

According to some embodiments of the present disclosure, a chip is provided. The chip includes one or more programmable logic circuits and/or one or more program instructions. The chip, when running, is caused to perform the method for controlling power or the method for muting transmission described above.

### BRIEF DESCRIPTION OF THE DRAWINGS

FIG. 1 is a schematic diagram of a network architecture according to some embodiments of the present disclosure;

FIG. 2 is a schematic diagram of SL communication transmission modes according to some embodiments of the present disclosure;

FIG. 3 is a schematic diagram of a physical layer structure in SL communication according to some embodiments of the present disclosure;

FIG. 4 is a schematic diagram of resource reservation according to some embodiments of the present disclosure;

FIG. 5 is a schematic diagram of sidelink power interference according to some embodiments of the present disclosure;

FIG. 6 is a schematic diagram of a sidelink path loss according to some embodiments of the present disclosure;

FIG. 7 is a schematic diagram of frequency-domain resources corresponding to PRSs according to some embodiments of the present disclosure;

FIG. 8 is a flowchart of a method for controlling power according to some embodiments of the present disclosure;

FIG. 9 is a flowchart of a method for controlling power according to some embodiments of the present disclosure;

FIG. 10 is a schematic diagram of a method for controlling power according to some embodiments of the present disclosure;

FIG. 11 is a schematic diagram of a method for controlling power according to some embodiments of the present disclosure;

FIG. 12 is a schematic diagram of a method for controlling power according to some embodiments of the present disclosure;

FIG. 13 is a schematic diagram of a method for controlling power according to some embodiments of the present disclosure;

FIG. 14 is a schematic diagram of a method for controlling power according to some embodiments of the present disclosure;

FIG. 15 is a flowchart of a method for controlling power according to some embodiments of the present disclosure;

FIG. 16 is a schematic diagram of a method for controlling power according to some embodiments of the present disclosure;

FIG. 17 is a schematic diagram of a method for controlling power according to some embodiments of the present disclosure;

FIG. 18 is a schematic diagram of a method for controlling power according to some embodiments of the present disclosure;

FIG. 19 is a schematic diagram of a method for controlling power according to some embodiments of the present disclosure;

FIG. 20 is a schematic diagram of a method for controlling power according to some embodiments of the present disclosure;

FIG. 21 is a flowchart of a method for muting transmission according to some embodiments of the present disclosure;

FIG. 22 is a schematic diagram of a method for muting transmission according to some embodiments of the present disclosure;

FIG. 23 is a schematic diagram of a method for muting transmission according to some embodiments of the present disclosure;

FIG. 24 is a block diagram of an apparatus for controlling power according to some embodiments of the present disclosure;

FIG. 25 is a block diagram of an apparatus for controlling power according to some embodiments of the present disclosure;

FIG. 26 is a block diagram of an apparatus for muting transmission according to some embodiments of the present disclosure; and

FIG. 27 is a schematic structural diagram of a terminal device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios described in the embodiments of the present disclosure are intended to describe the technical solutions according to the embodiments of the present disclosure more clearly, but do not constitute limitations on the technical solutions according to the embodiments of the present disclosure. Those of ordinary skill in the art understand that, with the evolution of the network architecture and the emergence of new service scenarios, the technical solutions according to the embodiments of the present disclosure are also applicable to similar technical problems.

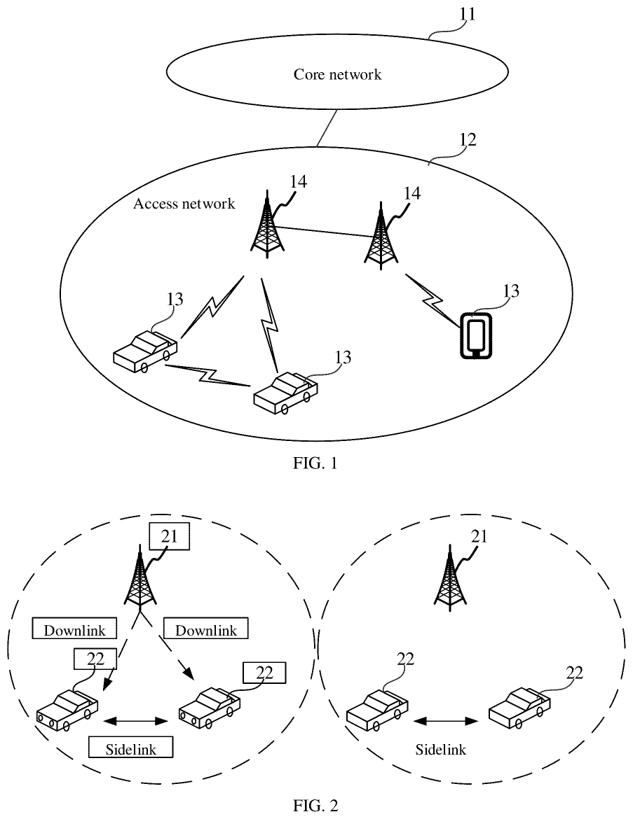

FIG. 1 is a schematic diagram of a network architecture according to some embodiments of the present disclosure. The network architecture includes: a core network 11, an access network 12, and terminal devices 13.

The core network 11 includes a plurality of core network devices. The core network devices mainly function to provide user connection, user management, and service bearing, and serve as a bearer network to provide an interface to an external network. For example, in a 5th generation (5G) new radio (NR) system, the core network may include devices such as an access and mobility management function (AMF) entity, a user plane function (UPF) entity, and a session management function (SMF) entity.

A plurality of access network devices 14 are deployed in the access network 12. In the 5G NR system, the access network may be referred to as a new generation-radio access network (NG-RAN). The access network devices 14 refer to devices deployed in the access network 12 to provide wireless communication functionality for the terminal devices 13. The access network device 14 may refer to various forms of macro base stations, micro base stations, relay stations, access points, and the like. The name of a device with the functionality of an access network device may vary in systems employing different radio access technologies. For example, the device is referred to as a gNodeB or a gNB in the 5G NR system. The term “access network device” may be referred to by different names with the evolution of communication technologies. For convenience of description, in the embodiments of the present disclosure, the above devices for providing the terminal devices 13 with the wireless communication functionality are collectively referred to as access network devices.

A plurality of terminal devices 13 are usually deployed, and one or more terminal devices 13 may be distributed in a cell managed by each of the access network devices 14. The terminal devices 13 may include various handheld devices, vehicle-mounted devices, wearable devices, computing devices, or other processing devices connected to a wireless modem with the wireless communication functionality, as well as various forms of UEs, mobile stations (MS), and the like. For convenience of description, the devices described above are collectively referred to as the terminal devices. The access network device 14 and the core network device communicate with each other over some air technologies, such as an NG interface in the 5G NR system. The access network devices 14 and the terminal devices 13 communicate with each other using a specific air technology, such as a Uu interface. In the present disclosure, the “terminal device” and the “UE” are used interchangeably. However, those skilled in the art understand that they generally convey the same meaning.

The terminal devices 13 (for example, the vehicle-mounted device and another device, such as another vehicle-mounted device, a mobile phone, or an RSU) may communicate with each other over a direct communication interface, such as a PC5 interface, and accordingly, the communication link established based on the direct communication interface may be referred to as a direct link or SL. The SL transmission means that the transmission of communication data is carried out directly between the terminal devices over a sidelink, which is different from a conventional cellular system in which the communication data is received or transmitted over an access network device. The SL transmission has characteristics of short delay and low overhead, and is therefore suitable for communication between two terminal devices that are geographically close to each other, for example, a vehicle-mounted device and another peripheral device that is geographically close to the vehicle-mounted device. It should be noted that, in FIG. 1, only vehicle-to-vehicle communication in a vehicle-to-everything (V2X) scenario is illustrated, while the SL technology is applicable to various scenarios in which communication is directly conducted between terminal devices. In other words, the terminal device in the present disclosure refers to any device that conducts communication using the SL technology.

The “5G NR system” in the embodiments of the present disclosure may also be referred to as a 5G system or an NR system, but those skilled in the art can understand the meaning thereof. The technical solutions described in the embodiments of the present disclosure are applicable to the 5G NR system, and also to a subsequent evolved system of the 5G NR system.

Before the technical solutions of the present disclosure are detailed, some background technical knowledge involved in the present disclosure is first explained. As an alternative, the following related technologies may be combined with the technical solutions of the embodiments of the present disclosure in any manner, all of which fall within the protection scope of the embodiments of the present disclosure. The embodiments of the present disclosure include at least part of the following content.

### 1. Sidelink

Unlike the traditional cellular system where communication data is received or transmitted by a base station, device-to-device communication is a sidelink transmission technology. For example, device-to-device direct communication is used in the V2X system, which offers higher spectrum efficiency and lower transmission delay. Regarding the device-to-device communication, 3^{rd} Generation Partnership Project (3GPP) has defined two transmission modes: a mode A and a mode B, as illustrated in FIG. 2.

In the mode A, transmission resources for terminal devices 22 are allocated by an access network device 21 (e.g., a base station). The terminal devices 22 transmit communication data on the sidelink over the transmission resources allocated by the access network device 21. The access network device 21 may allocate transmission resources to the terminal devices 22 for single transmission, or allocate transmission resources to the terminal devices 22 for semi-static transmission.

In the mode B, the terminal devices 22 select transmission resources from a resource pool autonomously and transmit communication data over the transmission resources. Specifically, the terminal devices 22 may select transmission resources from the resource pool either by means of monitoring or random selection.

In FIG. 2, only vehicle-to-vehicle communication is illustrated, while the SL technology may be applicable to various scenarios in which communication is directly conducted between terminal devices. In other words, the terminal device in the present disclosure refers to any terminal device that conducts communication using the SL technology.

### 2. Physical Layer Structure

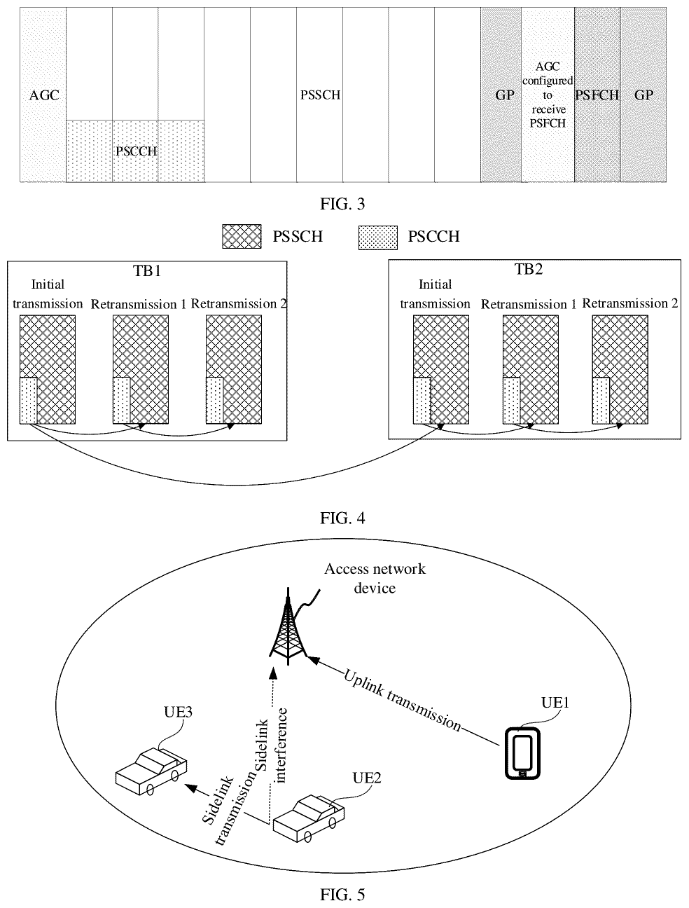

The physical layer structure of SL communication is illustrated in FIG. 3. The first symbol in the slot illustrated in FIG. 3 is an automatic gain control (AGC) symbol. During reception of the AGC symbol by the SL UE, the received power may be adjusted in the AGC symbol to a power suitable for demodulation. During transmission of the AGC symbol by the SL UE, the content in one symbol after the AGC symbol is repeatedly transmitted on the AGC symbol. The physical sidelink control channel (PSCCH) is configured to carry first sidelink control information. The physical sidelink shared channel (PSSCH) is configured to carry data and second sidelink control information. The PSCCH and PSSCH are transmitted in the same slot. The first sidelink control information and the second sidelink control information may be two types of sidelink control information of different roles. For example, the first sidelink control information, carried in the PSCCH, mainly includes fields related to resource monitoring, facilitating other terminal devices to perform resource exclusion and resource selection after decoding. In addition to the data, the second sidelink control information is also carried in the PSSCH, wherein the second sidelink control information mainly includes fields related to data demodulation, facilitating other terminal devices to demodulate the data in the PSSCH.

In a slot, a symbol corresponding to a physical sidelink feedback channel (PSFCH) may be present. The PSFCH is configured to transmit hybrid automatic repeat request (HARQ) feedback information. The symbol corresponding to the PSFCH may appear every 1, 2, or 4 slots, depending on the resource pool configuration. In the case that no symbol corresponding to the PSFCH is present in a certain slot, as illustrated in FIG. 3, the GAP symbol between the PSSCH and the PSFCH, the AGC symbol configured to receive the PSFCH, and the PSFCH symbol are all configured to carry the PSSCH. Typically, the last symbol in the slot is a guard period (GP) symbol, i.e., a GAP symbol. That is, the next symbol to the last symbol carrying the PSSCH or PSFCH is the GP symbol. The SL UE switches between transmission and reception in the GP symbol and does not perform transmission. In the case that PSFCH resources are present in the slot, the GP symbol is also present between the symbols of the PSSCH and the PSFCH. This is because the UE may perform transmission over the PSSCH and perform reception over the PSFCH, and the GP symbol is also needed for switching between transmission and reception.

### 3. Resource Reservation in NR V2X

In NR V2X, in the mode B described above, terminal devices autonomously select transmission resources from a resource pool and transmit communication data over the transmission resources, and resource reservation is a precondition for resource selection.

The resource reservation means that the terminal device transmits the first sidelink control information in the PSCCH to reserve resources to be used next. In NR V2X, intra-transport block (TB) resource reservation is supported, and inter-TB resource reservation is supported as well.

As illustrated in FIG. 4, the terminal device transmits the first sidelink control information, and indicates N time-frequency resources (including a resource used for current transmission) of a current TB by using the “time resource assignment” and “frequency resource assignment” fields in the first sidelink control information. N≤Nₘₐₓ, and Nₘₐₓ is equal to 2 or 3 in NR V2X. Meanwhile, the indicated N time-frequency resources should be distributed in W slots. W is equal to 32 in NR V2X. Exemplarily, in the TB 1 illustrated in FIG. 4, the terminal device transmits the first sidelink control information in the PSCCH while transmitting initial transmission data in the PSSCH, and indicates time-frequency resource positions for initial transmission and retransmission 1 (i.e., N=2 in this case) by using the two fields described above, i.e., to reserve a time-frequency resource for retransmission 1. Moreover, initial transmission and retransmission 1 are distributed in 32 slots in a time domain. Similarly, in the TB 1 illustrated in FIG. 4, the terminal device indicates time-frequency resource positions for retransmission 1 and retransmission 2 using the first sidelink control information transmitted in the PSCCH of retransmission 1, and retransmission 1 and Retransmission 2 are distributed in 32 slots in the time domain.

Meanwhile, in transmitting the first sidelink control information, the terminal device performs the inter-TB resource reservation by using a “resource reservation period” field. As illustrated in FIG. 4, in transmitting the first sidelink control information of initial transmission of the TB 1, the terminal device indicates time-frequency resource positions for data of initial transmission and retransmission 1 of the TB 1 by using the “time resource assignment” and “frequency resource assignment” fields, which are denoted as {(t₁, f₁), (t₂, f₂)}, wherein t₁ and t₂ represent time domain positions of resources for initial transmission and retransmission 1 of the TB 1, respectively, and f₁ and f₂ represent frequency domain positions of resources for initial transmission and retransmission 1 of the TB 1, respectively. In the case that a value of the “resource reservation period” field in the first sidelink control information is 100 ms, the sidelink control information (SCI) indicates time-frequency resources {(t₁+100, f₁), (t₂+100, f₂)} at the same time, which are used for initial transmission and retransmission 1 of the TB 2. Similarly, the first sidelink control information transmitted in retransmission 1 of the TB 1 also reserves time-frequency resources for retransmission 1 and retransmission 2 of the TB 2 by using the “resource reservation period” field. In NR V2X, the value for the “resource reservation period” field is possibly 0, 1-99, 100, 200, 300, 400, 500, 600, 700, 800, 900, and 1000 ms, which is more flexible than long-term evolution (LTE) V2X. However, only e values are configured in each resource pool, and the terminal device determines a possible value to be used based on the used resource pool. The e values in the resource pool configuration are denoted as a resource reservation period set M, and exemplarily, e is less than or equal to 16.

In addition, the inter-TB resource reservation described above may be activated or deactivated on a resource pool basis by means of network configuration or pre-configuration.

In the case that the terminal device operates in the mode B described above, the terminal device may acquire the first sidelink control information transmitted by other terminal devices by monitoring the PSCCHs transmitted by the other terminal devices, such that the resources reserved by the other terminal devices are acknowledged. In resource selection, the terminal device may exclude the resources reserved by the other terminal devices, such that resource collision is avoided.

### 4. Sidelink Power Control

The PSCCH and PSSCH of the NR V2X support two different types of power control, i.e., power control based on the downlink path loss and power control based on the sidelink path loss.

The power control based on the downlink path loss is mainly for reducing the interference of the sidelink transmission to the uplink reception. As illustrated in FIG. 5, since the sidelink communication may be located in the same carrier as the Uu uplink communication, the sidelink transmission between the UE 2 and the UE 3 may cause interference to the uplink reception of the access network device (e.g., a base station) for the UE 1, and upon introducing the power control based on the downlink path loss, the sidelink transmission power between the UE 2 and the UE 3 is reduced along with the reduction of the downlink path loss, such that the control of the uplink interference is achieved. The power control based on the sidelink path loss is mainly to reduce the interference between sidelink communications. As the power control based on the sidelink path loss relies on sidelink reference signal received power (SL-RSRP) feedback to calculate the sidelink path loss, only unicast communication in NR-V2X supports the power control based on the sidelink path loss.

The transmission power of the PSSCH on an orthogonal frequency division multiplexing (OFDM) symbol where only the PSSCH is present (the OFDM symbol where only the PSSCH is present as illustrated in FIG. 3) may be determined by using the following formula:

P_{PSSCH}(i)=min(P_{CMAX},P_{MAX,CBR},min(P_{PSSCH,D(i)}, P_{PSSCH,SL(i)}))[dBm]

P_{CMAX} represents the maximum transmission power allowed by the UE, P_{MAX, CBR} represents the maximum transmission power allowed for the current channel busy ratio (CBR) level and the priority of the transmitted data in the case of congestion control, and i represents the index of the OFDM symbol. P_{PSSCH, D(i)} and P_{PSSCH, SL(i)} represent the transmission power of the PSSCH determined based on the downlink path loss and the sidelink path loss, respectively, and are separately determined by using the following formulas:

In the case that P_{0, D} is configured by high-layer signaling:

$${P}_{PSSCH , D} ( i ) = {P}_{0 , D} + 10 {log}_{10} ( {2}^{μ} \cdot {M}_{RB}^{PSSCH} ( i ) ) + {α}_{D} \cdot {PL}_{D} [ dBm ]$$

$$Otherwise :$$

$${P}_{PSSCH , D} ( i ) = min ( {P}_{C MAX} , {P}_{MAX , CBR} ) [ dBm ]$$

In the case that P_{0, SL} is configured by high-layer signaling:

$${P}_{PSSCH , SL} ( i ) = {P}_{0 , SL} + 10 {log}_{10} ( {2}^{μ} \cdot {M}_{RB}^{PSSCH} ( i ) ) + {α}_{SL} \cdot {PL}_{SL} [ dBm ]$$

$$Otherwise :$$

$${P}_{PSSCH , SL} ( i ) = min ( {P}_{C MAX} , {P}_{PSSCH , D} ( i ) ) [ dBm ]$$

P_{0, D}/P_{0, SL} represents a basic operating point (or referred to as a target power) for the power control based on the downlink/sidelink path loss configured by the high-layer signaling, α_{D}/α_{SL} represents the downlink/sidelink path loss compensation factor configured by the high-layer signaling, PL_{D}/PL_{SL} represents the downlink/sidelink path loss estimated by the UE, M_{RB}^{PSSCH}(i) represents the number of physical resource blocks (PRBs) occupied by the PSSCH, and u represents the subcarrier spacing configuration.

In the case that both the PSCCH and the PSSCH are present in one OFDM symbol (the OFDM symbol where both the PSCCH and the PSSCH are present as illustrated in FIG. 3), the UE allocates transmission power P_{PSSCH}(i) to the PSCCH and the PSSCH based on the ratio of the number of PRBs of the PSCCH and the PSSCH. Specifically, in this case, the transmission power P_{PSSCH2}(i) of the PSSCH is:

$${P}_{PSSCH 2} ( i ) = 10 {log}_{10} ( \frac{{M}_{RB}^{PSSCH} ( i ) - {M}_{RB}^{PSCCH} ( i )}{{M}_{RB}^{PSSCH} ( i )} ) + {P}_{PSSCH} ( i ) [ dBm ]$$

The transmission power of the PSCCH is:

$${P}_{PSCCH} ( i ) = 10 {log}_{10} ( \frac{{M}_{RB}^{PSCCH} ( i )}{{M}_{RB}^{PSSCH} ( i )} ) + {P}_{PSSCH} ( i ) [ dBm ]$$

M_{RB}^{PSCCH}(i) represents the number of PRBs occupied by the PSCCH.

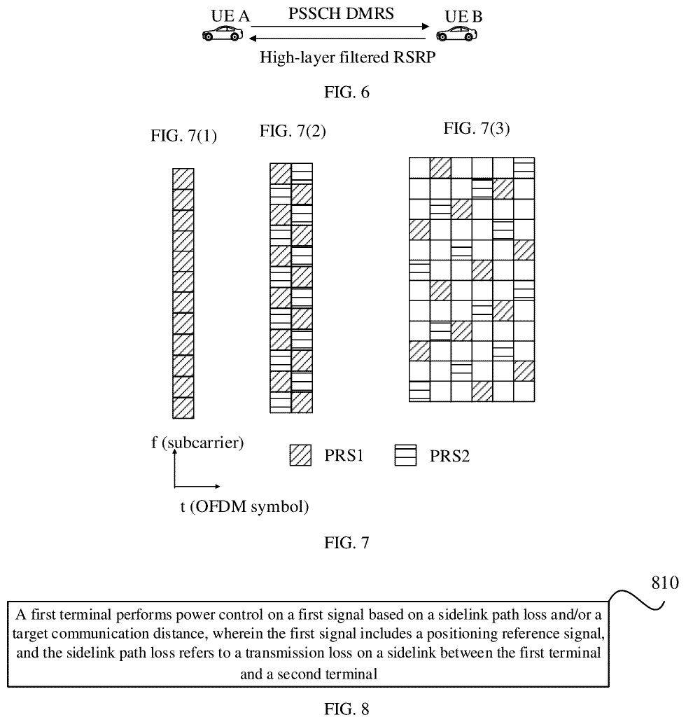

As can be known from the above description, the UE may control the transmission power based on the downlink path loss and/or the sidelink path loss. The downlink path loss may be obtained directly based on the downlink signal measurement. However, the sidelink path loss requires the receiver end to perform the RSRP feedback. As illustrated in FIG. 6, a UE A is a terminal device performing power control, a UE B measures RSRP based on a demodulation reference symbol (DMRS) of the PSSCH transmitted by the UE A, feeds back the high-layer filtered RSRP measurement result to the UE A, and the UE A determines the sidelink path loss based on its own transmission power and the RSRP measurement result fed back by the UE B. Exemplarily, the sidelink path loss is determined by subtracting the fed-back RSRP measurement result from the transmission power. In some embodiments, after performing high-layer filtering on the transmission power based on the same filtering coefficient, the UE A determines the sidelink path loss based on the transmission power and the RSRP measurement result fed back by the UE B.

### 5. PRS

The related standard protocol introduces the following downlink-related NR positioning methods: time difference of arrival (DL-TDOA), angle of departure (DL-AoD), and roundtrip time (multi-RTT) positioning methods. To support the UE in performing corresponding measurements for these positioning methods, a downlink positioning reference signal (DL PRS) is introduced in the related standard protocol. The UE acquires the measurement result required for each NR positioning method by measuring the DL PRS. As illustrated in FIG. 7, the PRS sequence may be mapped to all REs in a bandwidth on one OFDM symbol in a full resource element (RE) mapping manner, wherein one RE corresponds to one subcarrier in the frequency domain and one OFDM symbol in the time domain, i.e., the manner illustrated in FIG. 7(1). It is also possible to map to different REs in different OFDM symbols in a comb-like manner, but all the mapped REs need to occupy the whole bandwidth, i.e., the manner illustrated in FIG. 7(2) and FIG. 7(3). An access network device (e.g., a base station) and a terminal device determine time-frequency resources for transmitting and detecting a PRS based on the related configuration of the PRS.

Meanwhile, in DL PRS-based positioning, DL PRS muting is also introduced, which is performed based on the muting configuration of the DL PRS. This configuration is used to define that the DL PRS signal is not transmitted on some allocated time-frequency resources (referred to as muting). Muting means that the DL PRS signal is intentionally not transmitted on some designated time-frequency resources, rather than being transmitted on all allocated time-frequency resources. The purpose of this is to avoid collisions with other signals such as a synchronization signal block (SSB), and avoid interference between signals transmitted by different transmit receive points (TRPs). For example, the DL PRS transmission of a certain TRP is intentionally disabled at certain time, such that UE is capable of receiving the DL PRS signal from a distant TRP.

TDOA algorithm and RTT algorithm are two commonly used positioning algorithms. Taking the downlink as an example, the principle of TDOA is that a plurality of access network devices (e.g., base stations) transmit PRSs to the terminal device, the terminal device detects the plurality of PRSs, and the position of the terminal device is determined based on the arrival time difference of the plurality of detected PRSs. Therefore, TDOA generally requires a plurality of access network devices (e.g., base stations). RTT is commonly used to estimate distance. Taking the downlink as an example, the access network device (e.g., a base station) transmits a PRS1 to the terminal device, and the terminal device detects the PRS1 and transmits a PRS2 to the access network device (e.g., a base station) in response to the PRS1. The access network device (e.g., a base station) detects the PRS2, and the distance between the access network device (e.g., a base station) and the terminal device is determined based on the detection results of the PRS1 and the PRS2.

Currently, the standard is discussing SL-based positioning technologies, which involve positioning the target SL UE based on an RSU or anchor SL UE. Possible algorithms include TDOA algorithm, RTT algorithm, and the like. Similarly, the terminal device needs to acquire measurement quantities required by these algorithms, and thus, the PRS also needs to be transmitted between SL UEs and measurements are performed based on the PRS. In the case that the SL UE transmits the PRS, further research is needed on how to mute the SL UE or adjust the transmission power thereof so as to reduce interference to uplink transmission or other sidelink transmission. Based on this, the present disclosure provides a method for controlling power and a method for muting transmission, which may enable the terminal device to perform power control on or mute the transmitted sidelink PRS, such that interference to uplink transmission or other sidelink transmission is reduced and the reliability of the communication system is improved.

FIG. 8 is a flowchart of a method for controlling power according to some embodiments of the present disclosure. The method is applicable to a first terminal. The method includes process 810.

In process 810, the first terminal performs power control on a first signal based on a sidelink path loss and/or a target communication distance, wherein the first signal includes a positioning reference signal, and the sidelink path loss refers to a transmission loss on a sidelink between the first terminal and a second terminal.

In some embodiments, the positioning reference signal is a sidelink positioning reference signal. That is, the first signal includes a sidelink positioning reference signal.

In some embodiments, the first terminal and the second terminal are two different terminal devices, and transmission between the first terminal and the second terminal is performed over the sidelink. The first terminal is a terminal device that transmits the first signal, that is, the first terminal transmits the first signal to the second terminal over the sidelink. The second terminal is a terminal device that receives or detects the first signal, that is, the second terminal receives or detects the first signal transmitted by the first terminal over the sidelink.

Exemplarily, the first terminal is an anchor terminal, an RSU, or a target terminal (i.e., a terminal whose position needs to be acquired).

Exemplarily, the second terminal is an anchor terminal, an RSU, or a target terminal (i.e., a terminal whose position needs to be acquired).

Exemplarily, the first terminal is an anchor terminal or an RSU, and the second terminal is a terminal performing positioning based on the positioning reference signal.

Exemplarily, the RSU is a UE-type RSU.

Exemplarily, the first terminal is a terminal performing positioning based on the positioning reference signal, and the second terminal is an anchor terminal or an RSU.

In some embodiments, the sidelink path loss is determined based on the transmission power for transmitting a second signal by the first terminal to the second terminal over the sidelink, and the measurement result of the second terminal for the second signal. That is, the sidelink path loss is determined based on a first transmission power and a first measurement result. The first transmission power is the transmission power for transmitting the second signal by the first terminal to the second terminal over the sidelink, and the first measurement result is the measurement result of the second terminal for the second signal. Exemplarily, the first terminal transmits the second signal to the second terminal over the sidelink, and the transmission power for the second signal (i.e., the first transmission power) is P11. The second terminal performs a measurement on the second signal, and the measurement result is P12. The sidelink path loss is determined based on P11 and P12. Exemplarily, the sidelink path loss is P11 minus P12. Exemplarily, the measurement result for the second signal (i.e., the first measurement result) is the RSRP of the second signal. For this implementation, reference is specifically made to the description in the following embodiments.

In some embodiments, the sidelink path loss is determined based on the transmission power for transmitting a third signal by the second terminal to the first terminal over the sidelink, and the measurement result of the first terminal for the third signal. That is, the sidelink path loss is determined based on a second transmission power and a second measurement result. The second transmission power is the transmission power for transmitting the third signal by the second terminal to the first terminal over the sidelink, and the second measurement result is the measurement result of the first terminal for the third signal. Exemplarily, the second terminal transmits the third signal to the first terminal over the sidelink, and the transmission power for the third signal (i.e., the second transmission power) is P13. The first terminal performs a measurement on the third signal, and the measurement result is P14. The sidelink path loss is determined based on P13 and P14. Exemplarily, the sidelink path loss is P13 minus P14. Exemplarily, the measurement result for the third signal (i.e., the second measurement result) is the RSRP of the third signal. For this implementation, reference is specifically made to the description in the following embodiments.

In some embodiments, the target communication distance is configured by a network, pre-configured, specified as a predefined value in a standard, or dependent on the implementation of the first terminal. In some embodiments, the target communication distance is related to at least one of: positioning accuracy, a positioning algorithm, a positioning calculation capability, the priority of the first signal, or time-domain configuration parameters of the first signal. Exemplarily, the time-domain configuration parameters of the first signal may be parameters such as the period of the first signal, or the number of repeated transmissions of the first signal within the period, which is not limited in the present disclosure.

In some embodiments, the process that the first terminal performs power control on the first signal based on the target communication distance includes: determining, based on the corresponding relationship between the communication distance and the transmission power, the transmission power for the first signal according to a transmission power corresponding to the target communication distance. Exemplarily, the first terminal determines a transmission power corresponding to the target communication distance as the transmission power for the first signal. In some embodiments, the above corresponding relationship between the communication distance and the transmission power is configured by the network, pre-configured, specified as a predefined value in a standard, or dependent on the implementation of the first terminal.

In some embodiments, the above corresponding relationship between the communication distance and the transmission power is the corresponding relationship between one or more communication distances and one or more transmission powers. Exemplarily, the above corresponding relationship between the communication distance and the transmission power may include one or more sets of communication distances and transmission powers corresponding to each other. Each set of the communication distance and the transmission power corresponding to each other may be a set where one communication distance corresponds to one transmission power, a set where one communication distance corresponds to a plurality of transmission powers, or a set where a plurality of communication distances correspond to one transmission power. In addition, the communication distance described above may be a value or a value range. For example, the first terminal determines a communication distance value range to which the target communication distance belongs, determines a transmission power corresponding to the communication distance value range to which the target communication distance belongs based on the corresponding relationship between the communication distance and the transmission power, and further determines the transmission power for the first signal based on the determined transmission power.

In some embodiments, whether performing power control on the first signal based on the sidelink path loss and/or the target communication distance is configured by the network, pre-configured, or dependent on the implementation of the first terminal.

In some embodiments, the first terminal also performs power control on the first signal based on the downlink path loss. In some embodiments, the downlink path loss is determined based on the measurement result for a downlink signal and a reference transmission power. In some embodiments, the reference transmission power is configured by the network, pre-configured, or specified as a predefined value in a standard. In some embodiments, the downlink signal is a physical downlink control channel (PDCCH), a physical downlink shared channel (PDSCH), or an SSB, which is not limited in the present disclosure. Exemplarily, the downlink path loss is the reference transmission power minus the measurement result for the downlink signal. Exemplarily, the measurement result for the downlink signal is the RSRP of the downlink signal.

In some embodiments, the first terminal also performs power control on the first signal based on a channel busy ratio measured by the first terminal. The channel busy ratio refers to the ratio of the number of sub-channels whose received signal strength indicator (RSSI) is greater than the network-configured or pre-configured threshold within the CBR measurement window to the total number of sub-channels in the CBR measurement window.

In some embodiments, the first terminal performs power control on the first signal based on at least one of the sidelink path loss, the target communication distance, the downlink path loss, or the channel busy ratio. Exemplarily, the maximum transmission power of the first terminal is assumed to be P1. In some embodiments, the first terminal determines the transmission power for the first signal as P2 based on the sidelink path loss. In some embodiments, the first terminal determines the transmission power for the first signal as P3 based on the target communication distance. In some embodiments, the first terminal determines the transmission power for the first signal as P4 based on the downlink path loss. In some embodiments, the first terminal determines the transmission power for the first signal as P5 based on the channel busy ratio. Finally, the transmission power for the first signal determined by the first terminal is the minimum value of one or more of P1, P2, P3, P4, and P5. For example, in the case that the network configures the first terminal to perform power control on the first signal based on the sidelink path loss, the target communication distance, and the downlink path loss, the transmission power for the first signal finally determined by the first terminal is the minimum value of P1, P2, P3, and P4.

In some embodiments, in the case that the positioning reference signal and a signal corresponding to the PSCCH are mapped on the frequency-domain resources corresponding to the same time unit, the transmission power for the positioning reference signal and the transmission power for the signal corresponding to the PSCCH are allocated based on the ratio of the frequency-domain resources occupied. That is, for the transmission power for the first signal finally determined by the first terminal described above, in the case that the positioning reference signal and the signal corresponding to the PSCCH are mapped on the frequency-domain resources corresponding to the same time unit, the transmission power for the positioning reference signal and the transmission power for the signal corresponding to the PSCCH are allocated based on the ratio of the frequency-domain resources occupied.

Exemplarily, the positioning reference signal and the signal corresponding to the PSCCH are mapped on the frequency-domain resources corresponding to the same time unit, wherein the ratio of the frequency-domain resources occupied by the positioning reference signal and the signal corresponding to the PSCCH is 2:3, and then the transmission power for the positioning reference signal and the transmission power for the signal corresponding to the PSCCH are allocated according to the ratio of 2:3.

In the technical solutions according to the embodiments, the first terminal performs power control on the first signal including a PRS based on the sidelink path loss and/or the target communication distance. In this way, the SL terminal is capable of performing power control on the transmitted PRS to transmit the PRS on the sidelink with an appropriate transmission power, such that interference to uplink transmission or other sidelink transmission is reduced and the reliability of the communication system is improved.

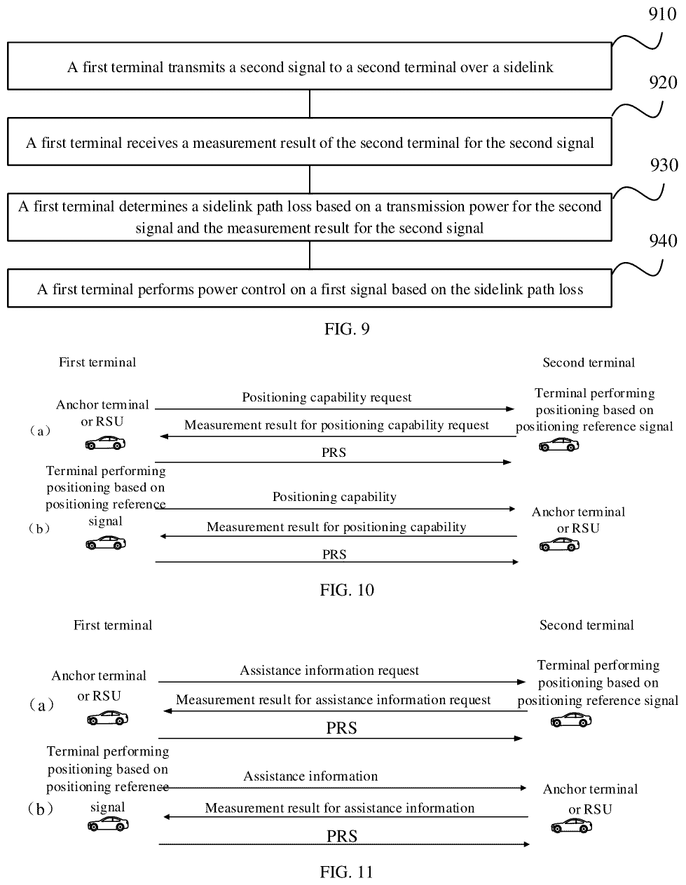

FIG. 9 is a flowchart of a method for controlling power according to some embodiments of the present disclosure. The method is applicable to a first terminal. The method may include at least one of processes 910 to 940.

In process 910, the first terminal transmits a second signal to a second terminal over a sidelink.

In process 920, the first terminal receives a first measurement result. That is, the first terminal receives the measurement result of the second terminal for the second signal.

In process 930, the first terminal determines a sidelink path loss based on a first transmission power and the first measurement result. That is, the first terminal determines the sidelink path loss based on the transmission power for the second signal and the measurement result for the second signal.

In process 940, the first terminal performs power control on a first signal based on the sidelink path loss.

In some embodiments, the second signal includes at least one of: radio resource control (RRC) signaling, medium access control (MAC) control element (CE) signaling, a signal carried over a PSCCH, a signal carried over a PSSCH, or a positioning reference signal (PRS).

In some embodiments, the function of the second signal includes at least one of:
transmitting a positioning capability request, or transmitting a positioning capability;
transmitting an assistance information request, or transmitting assistance information;
transmitting a position information request, transmitting position information, or transmitting a position calculation result; or
transmitting a positioning reference signal.

Exemplarily, the second signal is defined to transmit a positioning capability request, or to transmit a positioning capability.

In some embodiments, as illustrated in FIG. 10(a), the first terminal is an anchor terminal or an RSU, and the second terminal is a terminal performing positioning based on the positioning reference signal (or referred to as a target terminal). The first terminal transmits the second signal to the second terminal, wherein the second signal is defined to transmit a positioning capability request (or the second signal is a positioning capability request), i.e., to request the second terminal to provide its positioning capability. The positioning capability includes, but is not limited to, at least one of: a supported positioning algorithm, a signal measurement capability, a positioning calculation capability, or the like. The second terminal receives the second signal, measures the received power for the second signal, and reports the first measurement result to the first terminal. The first terminal receives the first measurement result and determines the sidelink path loss based on the first transmission power and the first measurement result. The first terminal performs power control on the first signal (e.g., a PRS) based on the sidelink path loss.

In some embodiments, as illustrated in FIG. 10(b), the first terminal is a terminal performing positioning based on the positioning reference signal (or referred to as a target terminal), and the second terminal is an anchor terminal or an RSU. The first terminal transmits the second signal to the second terminal, wherein the second signal is defined to transmit a positioning capability (or the second signal is the information defined to indicate the positioning capability). The positioning capability includes, but is not limited to, at least one of: a supported positioning algorithm, a signal measurement capability, a positioning calculation capability, or the like. The second terminal receives the second signal, measures the received power for the second signal, and reports the first measurement result to the first terminal. The first terminal receives the first measurement result and determines the sidelink path loss based on the first transmission power and the first measurement result. The first terminal performs power control on the first signal (e.g., a PRS) based on the sidelink path loss.

Exemplarily, the second signal is defined to transmit an assistance information request, or to transmit assistance information.

In some embodiments, as illustrated in FIG. 11(a), the first terminal is a terminal performing positioning based on the positioning reference signal (or referred to as a target terminal), and the second terminal is an anchor terminal or an RSU. The first terminal transmits the second signal to the second terminal, wherein the second signal is defined to transmit an assistance information request (or the second signal is an assistance information request), i.e., to request the second terminal to provide assistance information. The assistance information includes, but is not limited to, at least one of: configuration parameters of the positioning reference signal, configuration parameters of the time-frequency resources, configuration parameters of the bandwidth, or the like. The second terminal receives the second signal, detects the received power for the second signal, and reports the first measurement result to the first terminal. The first terminal receives the first measurement result and determines the sidelink path loss based on the first transmission power and the first measurement result. The first terminal performs power control on the first signal based on the sidelink path loss.

In some embodiments, as illustrated in FIG. 11(b), the first terminal is an anchor terminal or an RSU, and the second terminal is a terminal performing positioning based on the positioning reference signal (or referred to as a target terminal). The first terminal transmits the second signal to the second terminal, wherein the second signal is defined to transmit assistance information (or the second signal is assistance information). The assistance information includes, but is not limited to, at least one of: configuration parameters of the positioning reference signal, configuration parameters of the time-frequency resources, configuration parameters of the bandwidth, or the like. The second terminal receives the second signal, measures the received power for the second signal, and reports the first measurement result to the first terminal. The first terminal receives the first measurement result and determines the sidelink path loss based on the first transmission power and the first measurement result. The first terminal performs power control on the first signal (e.g., a PRS) based on the sidelink path loss.

Exemplarily, the second signal is defined to transmit a position information request, to transmit position information, or to transmit a position calculation result.

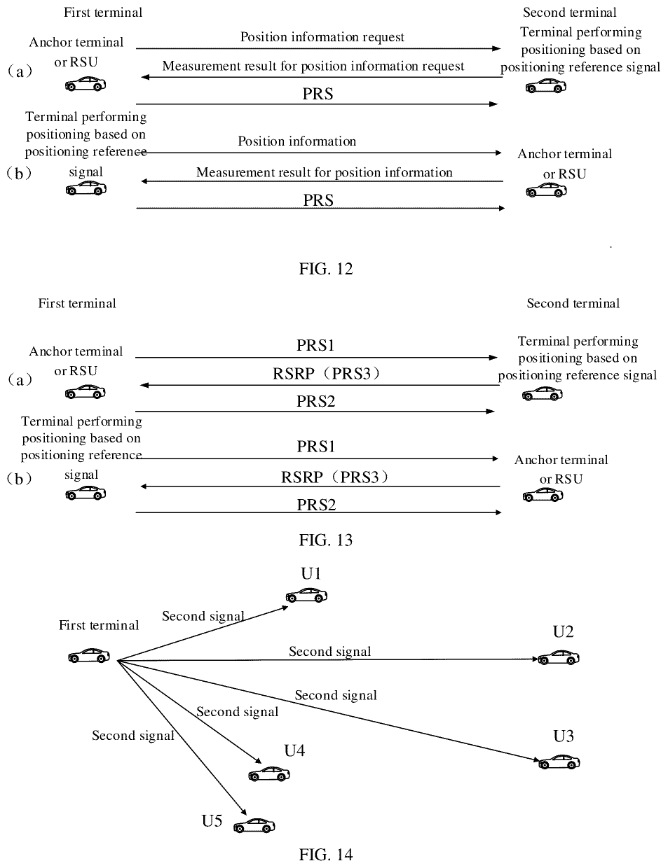

In some embodiments, as illustrated in FIG. 12(a), the first terminal is an anchor terminal or an RSU, and the second terminal is a terminal performing positioning based on the positioning reference signal (or referred to as a target terminal). The first terminal transmits the second signal to the second terminal, wherein the second signal is defined to transmit a position information request (or the second signal is a position information request), i.e., to request the second terminal to provide its position information. The position information includes the measurement result obtained based on the positioning reference signal. The second terminal receives the second signal, measures the received power for the second signal, and reports the first measurement result to the first terminal. The first terminal receives the first measurement result and determines the sidelink path loss based on the first transmission power and the first measurement result. The first terminal performs power control on the first signal (e.g., a PRS) based on the sidelink path loss.

In some embodiments, as illustrated in FIG. 12(b), the first terminal is a terminal performing positioning based on the positioning reference signal (or referred to as a target terminal), and the second terminal is an anchor terminal or an RSU. The first terminal transmits the second signal to the second terminal, wherein the second signal is defined to transmit position information (or the second signal is position information). The position information includes the measurement result obtained based on the positioning reference signal. The second terminal receives the second signal, measures the received power for the second signal, and reports the first measurement result to the first terminal. The first terminal receives the first measurement result and determines the sidelink path loss based on the first transmission power and the first measurement result. The first terminal performs power control on the first signal (e.g., a PRS) based on the sidelink path loss.

Exemplarily, the second signal is defined to transmit a positioning reference signal.

In some embodiments, as illustrated in FIG. 13(a), the first terminal is an anchor terminal or an RSU, and the second terminal is a terminal performing positioning based on the positioning reference signal (or referred to as a target terminal). The first terminal transmits the second signal to the second terminal, wherein the second signal is defined to transmit a PRS1 (or the second signal is a PRS1). The second terminal reports the measurement result to the first terminal based on the PRS1. The measurement result refers to the reference signal received power (RSRP) obtained by measuring the PRS1. The first terminal receives the RSRP obtained by measuring the PRS1 by the second terminal, and determines the sidelink path loss based on the transmission power for the PRS1 and the RSRP obtained by measuring the PRS1 by the second terminal. The first terminal performs power control on the first signal (e.g., a PRS2) based on the sidelink path loss. In some embodiments, the second terminal reports the corresponding RSRP obtained by measuring the PRS1 while transmitting a PRS3 to the first terminal. In some embodiments, the RSRP obtained by measuring the PRS1 is indicated in the sidelink control information associated with the PRS3.

In some embodiments, as illustrated in FIG. 13(b), the first terminal is a terminal performing positioning based on the positioning reference signal (or referred to as a target terminal), and the second terminal is an anchor terminal or an RSU. The first terminal transmits the second signal to the second terminal, wherein the second signal is defined to transmit a PRS1 (or the second signal is a PRS1). The second terminal reports the measurement result to the first terminal based on the PRS1. The measurement result refers to the RSRP obtained by measuring the PRS1. The first terminal receives the RSRP obtained by measuring the PRS1 by the second terminal, and determines the sidelink path loss based on the transmission power for the PRS1 and the RSRP obtained by measuring the PRS1 by the second terminal. The first terminal performs power control on the first signal (e.g., a PRS2) based on the sidelink path loss. In some embodiments, the second terminal reports the corresponding RSRP obtained by measuring the PRS1 while transmitting a PRS3 to the first terminal. In some embodiments, the RSRP obtained by measuring the PRS1 is indicated in the sidelink control information associated with the PRS3.

In some embodiments, a plurality of second terminals are deployed, and the first terminal transmits the second signal to the plurality of second terminals.

In some embodiments, the first terminal transmits the second signal to the plurality of second terminals separately by means of unicast or multicast at the same time point, and the first terminal also transmits the second signal to the plurality of second terminals by means of multicast or broadcast. Exemplarily, as illustrated in FIG. 14, five second terminals are deployed, which are U1, U2, U3, U4, and U5, respectively. In some embodiments, the first terminal unicasts the second signal to U1, U2, U3, U4, and U5 separately at the same time point. In some embodiments, U1 and U2 form a first multicast group, and U3, U4, and U5 form a second multicast group; the first terminal transmits the second signal to the first multicast group and the second multicast group at the same time point. In some embodiments, U1, U2, U3, U4, and U5 form a multicast group to which the first terminal transmits the second signal at the same time point. In some embodiments, the first terminal broadcasts the second signal to U1, U2, U3, U4, and U5.

In some embodiments, the first terminal also transmits the second signal to the plurality of second terminals separately at different time points by means of unicast or multicast.

Exemplarily, as illustrated in FIG. 14, five second terminals are deployed, which are U1, U2, U3, U4, and U5, respectively. The first terminal transmits the second signal at time points T1 and T2 separately. In some embodiments, the first terminal unicasts the second signal to U1, U2, U3, U4, and U5 at time points T1 and T2 separately. For example, the first terminal unicasts the second signal to U1 and U2 at the time point T1, and unicasts the second signal to U3, U4, and U5 at the time point T2. In some embodiments, U1 and U2 form a first multicast group, and U3, U4, and U5 form a second multicast group; the first terminal transmits the second signal to the first multicast group at the time point T1 and transmits the second signal to the second multicast group at the time point T2.

In some embodiments, the second terminal reports the measurement result for the second signal (i.e., the first measurement result) to the first terminal at the same time point, or reports the measurement result for the second signal (i.e., the first measurement result) to the first terminal at different time points.

Exemplarily, as illustrated in FIG. 14, five second terminals are deployed, which are U1, U2, U3, U4, and U5, respectively. In some embodiments, the second terminal reports the first measurement result to the first terminal at the same time point. For example, U1, U2, U3, U4, and U5 report the first measurement result to the first terminal at a time point T3. In some embodiments, the second terminal reports the first measurement result to the first terminal at time points T3 and T4 separately. For example, U1 and U2 report the first measurement result to the first terminal at the time point T3, and U3, U4, and U5 report the first measurement result to the first terminal at the time point T4.

In some embodiments, the first terminal determines a plurality of sidelink path losses based on the first transmission power and first measurement results respectively corresponding to the plurality of second terminals, selects the maximum value among the plurality of sidelink path losses as the sidelink path loss for performing power control on the first signal, and performs power control on the first signal based on the sidelink path loss.

In some embodiments, the first terminal determines a first measurement result with the worst signal quality from the first measurement results respectively corresponding to the plurality of second terminals, determines the sidelink path loss based on the first transmission power and the first measurement result with the worst signal quality, and performs power control on the first signal based on the sidelink path loss.

In the embodiments of the present disclosure, signal quality is described by a signal quality parameter, i.e., the measurement result or measurement quantity for the signal. Poor signal quality means that the value of the signal quality parameter described above is small (or low), that is, the value of the measurement result or the measurement quantity is small (or low). The worst signal quality means that the value of the signal quality parameter described above is the smallest (or lowest), that is, the value of the measurement result or the measurement quantity is the smallest (or lowest). The measurement result or the measurement quantity of the signal quality is the RSRP.

In some embodiments, the first terminal determines a plurality of sidelink path losses based on the first transmission power and first measurement results corresponding to the plurality of second terminals, determines the transmission powers for a plurality of first signals, respectively, based on the plurality of sidelink path losses, and selects the maximum value among the transmission powers for the plurality of first signals to perform power control on the first signal.

Exemplarily, as illustrated in FIG. 14, five second terminals are deployed, which are U1, U2, U3, U4, and U5, respectively. The first measurement result measured by U1 is R1, the first measurement result measured by U2 is R2, the first measurement result measured by U3 is R3, the first measurement result measured by U4 is R4, and the first measurement result measured by U5 is R5, wherein R1 has the worst signal quality.

In some embodiments, the first terminal separately determines five candidate sidelink path losses P1, P2, P3, P4, and P5 based on the first transmission power and R1, R2, R3, R4, and R5, selects the maximum value P1 among the five candidate sidelink path losses as the sidelink path loss, and performs power control on the first signal based on the sidelink path loss.

In some embodiments, the first terminal selects R1 with the worst signal quality among R1, R2, R3, R4, and R5, determines the sidelink path loss based on the first transmission power and R1, and performs power control on the first signal based on the sidelink path loss.

In some embodiments, the first terminal separately determines five sidelink path losses P1, P2, P3, P4, and P5 based on the first transmission power and R1, R2, R3, R4, and R5, determines the transmission powers for a plurality of candidate first signals based on P1, P2, P3, P4, and P5, and selects the maximum value among the transmission powers for the plurality of candidate first signals to perform power control on the first signal.

Based on the method described above, it is ensured that in the case that the first terminal transmits the first signal and the first signal is detected by the plurality of second terminals, the second terminal with the worst channel quality may also be covered.

In the technical solutions according to the embodiments, the first terminal transmits the second signal to the second terminal, the second terminal measures the second signal, so as to determine the sidelink path loss, and the first terminal performs power control on the first signal including a PRS based on the sidelink path loss. In this way, the SL terminal is capable of performing power control on the transmitted PRS to transmit the PRS on the sidelink with an appropriate transmission power, such that interference to uplink transmission or other sidelink transmission is reduced and the reliability of the communication system is improved.

In addition, the embodiments provide various methods for acquiring the sidelink path loss, which improve the diversity and flexibility of the SL terminal for acquiring the PRS transmission power, and meet the requirements of the SL terminal for performing power control on the transmitted PRS in more scenarios.

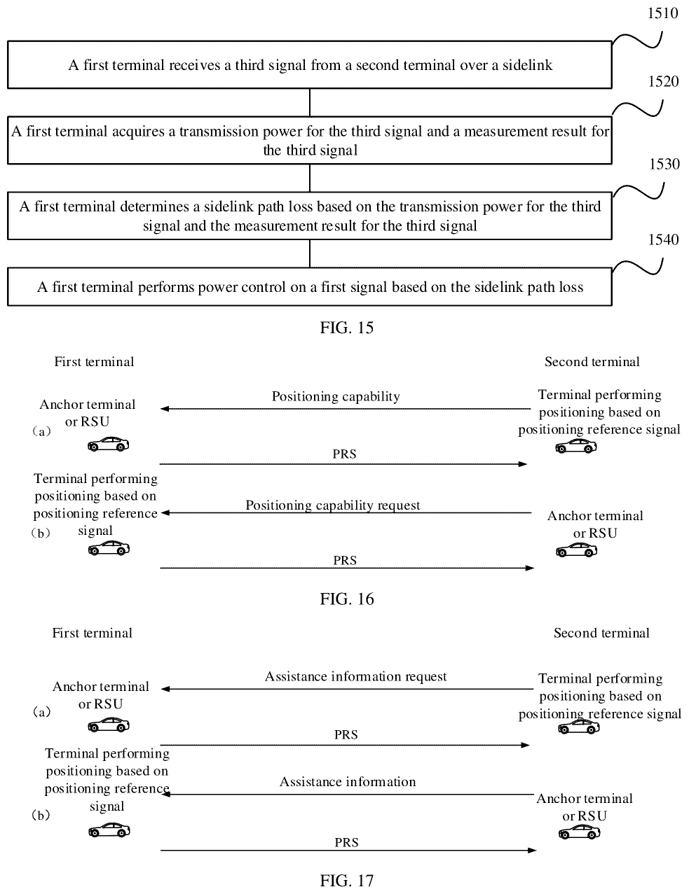

FIG. 15 is a flowchart of a method for controlling power according to some embodiments of the present disclosure. The method is applicable to a first terminal. The method may include at least one of processes 1510 to 1540:

In process 1510, the first terminal receives a third signal from a second terminal over a sidelink.

In process 1520, the first terminal acquires a second transmission power and a second measurement result. That is, the first terminal acquires the transmission power for the third signal and the measurement result for the third signal.

In process 1530, the first terminal determines a sidelink path loss based on the second transmission power and the second measurement result. That is, the first terminal determines the sidelink path loss based on the transmission power for the third signal and the measurement result for the third signal.

In process 1540, the first terminal performs power control on a first signal based on the sidelink path loss.

In some embodiments, the third signal includes at least one of: RRC signaling, MAC CE signaling, a signal carried over a PSCCH, a signal carried over a PSSCH, or a positioning reference signal (PRS).

In some embodiments, the function of the third signal includes at least one of:
transmitting a positioning capability request, or transmitting a positioning capability;
transmitting an assistance information request, or transmitting assistance information;
transmitting a position information request, transmitting position information, or transmitting a position calculation result; or
transmitting a positioning reference signal.

Exemplarily, the third signal is defined to transmit a positioning capability request, or to transmit a positioning capability.

In some embodiments, as illustrated in FIG. 16(a), the first terminal is an anchor terminal or an RSU, and the second terminal is a terminal performing positioning based on the positioning reference signal (or referred to as a target terminal). The second terminal transmits the third signal to the first terminal and indicates the second transmission power, wherein the third signal is defined to transmit a positioning capability (or the third signal is a positioning capability). The positioning capability includes, but is not limited to, at least one of: a supported positioning algorithm, a signal measurement capability, a positioning calculation capability, or the like. The first terminal receives the third signal and the second transmission power, measures the received power for the third signal, and determines the sidelink path loss based on the second transmission power and the second measurement result. The first terminal performs power control on the first signal (e.g., a PRS) based on the sidelink path loss. Exemplarily, the second terminal indicates the second transmission power in the sidelink control information associated with the third signal.

In some embodiments, as illustrated in FIG. 16(b), the first terminal is a terminal performing positioning based on the positioning reference signal (or referred to as a target terminal), and the second terminal is an anchor terminal or an RSU. The second terminal transmits the third signal to the first terminal and indicates the second transmission power, wherein the third signal is defined to transmit a positioning capability request (or the third signal is a positioning capability request), i.e., to request the first terminal to report its positioning capability. The positioning capability includes, but is not limited to, at least one of: a supported positioning algorithm, a signal measurement capability, a positioning calculation capability, or the like. The first terminal receives the third signal and the second transmission power, measures the received power for the third signal, and determines the sidelink path loss based on the second transmission power and the second measurement result. The first terminal performs power control on the first signal (e.g., a PRS) based on the sidelink path loss. Exemplarily, the second terminal indicates the second transmission power in the sidelink control information associated with the third signal.

Exemplarily, the third signal is defined to transmit an assistance information request, or to transmit assistance information.

In some embodiments, as illustrated in FIG. 17(a), the first terminal is an anchor terminal or an RSU, and the second terminal is a terminal performing positioning based on the positioning reference signal (or referred to as a target terminal). The second terminal transmits the third signal to the first terminal and indicates the second transmission power, wherein the third signal is defined to transmit an assistance information request (or the third signal is an assistance information request), i.e., to request the first terminal to provide its assistance information. The assistance information includes, but is not limited to, at least one of: configuration parameters of the positioning reference signal, configuration parameters of the time-frequency resources, configuration parameters of the bandwidth, or the like. The first terminal receives the third signal and the second transmission power, measures the received power for the third signal, and determines the sidelink path loss based on the second transmission power and the second measurement result. The first terminal performs power control on the first signal (e.g., a PRS) based on the sidelink path loss. Exemplarily, the second terminal indicates the second transmission power in the sidelink control information associated with the third signal.

In some embodiments, as illustrated in FIG. 17(b), the first terminal is a terminal performing positioning based on the positioning reference signal (or referred to as a target terminal), and the second terminal is an anchor terminal or an RSU. The second terminal transmits the third signal to the first terminal and indicates the second transmission power, wherein the third signal is defined to transmit assistance information (or the third signal is assistance information). The assistance information includes, but is not limited to, at least one of: configuration parameters of the positioning reference signal, configuration parameters of the time-frequency resources, configuration parameters of the bandwidth, or the like. The first terminal receives the third signal and the second transmission power, measures the received power for the third signal, and determines the sidelink path loss based on the second transmission power and the second measurement result. The first terminal performs power control on the first signal (e.g., a PRS) based on the sidelink path loss. Exemplarily, the second terminal indicates the second transmission power in the sidelink control information associated with the third signal.

Exemplarily, the third signal is defined to transmit a position information request, to transmit position information, or to transmit a position calculation result.

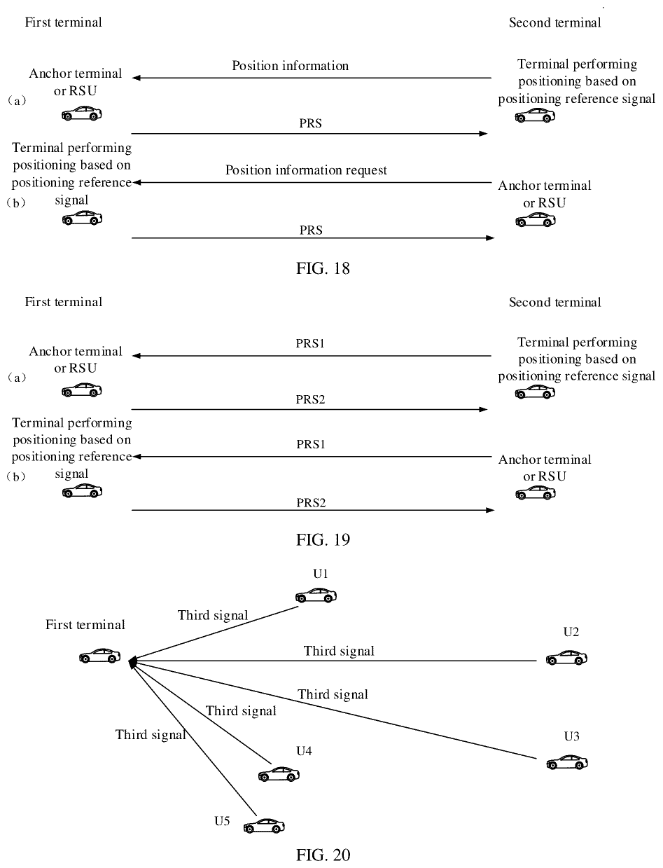

In some embodiments, as illustrated in FIG. 18(a), the first terminal is an anchor terminal or an RSU, and the second terminal is a terminal performing positioning based on the positioning reference signal (or referred to as a target terminal). The second terminal transmits the third signal to the first terminal and indicates the second transmission power, wherein the third signal is defined to transmit position information (or the third signal is position information). The position information includes the measurement result obtained based on the positioning reference signal. The first terminal receives the third signal and the second transmission power, measures the received power for the third signal, and determines the sidelink path loss based on the second transmission power and the second measurement result. The first terminal performs power control on the first signal (e.g., a PRS) based on the sidelink path loss. Exemplarily, the second terminal indicates the second transmission power in the sidelink control information associated with the third signal.

In some embodiments, as illustrated in FIG. 18(b), the first terminal is a terminal performing positioning based on the positioning reference signal (or referred to as a target terminal), and the second terminal is an anchor terminal or an RSU. The second terminal transmits the third signal to the first terminal and indicates the second transmission power, wherein the third signal is defined to transmit a position information request (or the third signal is a position information request), i.e., to request the first terminal to report its position information. The position information includes the measurement result obtained based on the positioning reference signal. The first terminal receives the third signal and the second transmission power, measures the received power for the third signal, and determines the sidelink path loss based on the second transmission power and the second measurement result. The first terminal performs power control on the first signal (e.g., a PRS) based on the sidelink path loss. Exemplarily, the second terminal indicates the second transmission power in the sidelink control information associated with the third signal.

Exemplarily, the third signal is defined to transmit a positioning reference signal.

As illustrated in FIG. 19(a), the first terminal is an anchor terminal or an RSU, and the second terminal is a terminal performing positioning based on the positioning reference signal (or referred to as a target terminal). The second terminal transmits the third signal to the first terminal and indicates the second transmission power, wherein the third signal is defined to transmit a PRS1 (or the third signal is a PRS1). The first terminal receives the PRS1 and the transmission power for the PRS1, and measures the received power for the PRS1 to obtain a measurement result. The measurement result refers to the RSRP obtained by measuring the PRS1. The first terminal determines the sidelink path loss based on the transmission power for the PRS1 and the RSRP obtained by measuring the PRS1. The first terminal performs power control on the first signal (e.g., a PRS2) based on the sidelink path loss. Exemplarily, the second terminal indicates the second transmission power in the sidelink control information associated with the third signal.

As illustrated in FIG. 19(b), the first terminal is an anchor terminal or an RSU, and the second terminal is a terminal performing positioning based on the positioning reference signal (or referred to as a target terminal). The second terminal transmits the third signal to the first terminal and indicates the second transmission power, wherein the third signal is defined to transmit a PRS1 (or the third signal is a PRS1). The first terminal receives the PRS1 and the transmission power for the PRS1, and measures the received power for the PRS1 to obtain a measurement result. The measurement result refers to the RSRP obtained by measuring the PRS1. The first terminal determines the sidelink path loss based on the transmission power for the PRS1 and the RSRP obtained by measuring the PRS1. The first terminal performs power control on the first signal (e.g., a PRS2) based on the sidelink path loss. Exemplarily, the second terminal indicates the second transmission power in the sidelink control information associated with the third signal.

In some embodiments, a plurality of second terminals are deployed, and the plurality of second terminals transmit the third signal to the first terminal over the sidelink. In some embodiments, the plurality of second terminals described above also indicate their corresponding second transmission powers to the first terminal. Exemplarily, the second terminal indicates its corresponding second transmission power in the sidelink control information associated with the third signal transmitted by the second terminal.

In some embodiments, the plurality of second terminals transmit the third signal to the first terminal at the same time point, or transmits the third signal to the first terminal at different time points, which is not limited in the present disclosure.

Exemplarily, as illustrated in FIG. 20, five second terminals are deployed, which are U1, U2, U3, U4, and U5, respectively. In some embodiments, the second terminal transmits the third signal to the first terminal at the same time point. For example, U1, U2, U3, U4, and U5 transmit the third signal to the first terminal at the time point T5. In some embodiments, the second terminal transmits the third signal to the first terminal at time points T5 and T6 separately. For example, U1 and U2 transmit the third signal to the first terminal at the time point T5, and U3, U4, and U5 transmit the third signal to the first terminal at the time point T6.

In some embodiments, the first terminal determines sidelink path losses respectively corresponding to the plurality of second terminals based on the second transmission powers and the second measurement results respectively corresponding to the plurality of second terminals, selects the maximum value among the sidelink path losses respectively corresponding to the plurality of second terminals as the sidelink path loss for performing power control on the first signal, and performs power control on the first signal based on the sidelink path loss.

In some embodiments, the first terminal determines sidelink path losses respectively corresponding to the plurality of second terminals based on the second transmission powers and the second measurement results respectively corresponding to the plurality of second terminals, determines the transmission powers for the first signal respectively corresponding to the plurality of second terminals based on the sidelink path losses respectively corresponding to the plurality of second terminals, and selects the maximum value among the transmission powers for the first signal respectively corresponding to the plurality of second terminals to perform power control on the first signal.

Exemplarily, as illustrated in FIG. 20, five second terminals are deployed, which are U1, U2, U3, U4, and U5, respectively. The second transmission powers are F1, F2, F3, F4, and F5, respectively. The second measurement result for U1 by the first terminal is R1, the second measurement result for U2 by the first terminal is R2, the second measurement result for U3 by the first terminal is R3, the second measurement result for U4 by the first terminal is R4, and the second measurement result for U5 by the first terminal is R5, wherein R1 has the worst signal quality.

In some embodiments, the first terminal determines the sidelink path losses P1, P2, P3, P4, and P5 respectively corresponding to the above five second terminals based on F1, F2, F3, F4, and F5, and R1, R2, R3, R4, and R5. The first terminal selects the maximum value among P1, P2, P3, P4, and P5 as the sidelink path loss for performing power control on the first signal, and performs power control on the first signal based on the sidelink path loss.

In some embodiments, the first terminal determines the sidelink path losses P1, P2, P3, P4, and P5 respectively corresponding to the above five second terminals based on F1, F2, F3, F4, and F5, and R1, R2, R3, R4, and R5. The first terminal determines the transmission powers for the first signal respectively corresponding to the above five second terminals based on P1, P2, P3, P4, and P5. The first terminal selects the maximum value among the transmission powers for the first signal respectively corresponding to the above five second terminals to perform power control on the first signal.

Based on the method described above, it is ensured that in the case that the first terminal transmits the first signal and the first signal is detected by the plurality of second terminals, the second terminal with the worst channel quality may also be covered.

In the technical solutions according to the embodiments of the present disclosure, the second terminal transmits the third signal to the first terminal, and the first terminal measures the third signal, so as to determine the sidelink path loss. The first terminal performs power control on the first signal including a PRS based on the sidelink path loss. In this way, the SL terminal is capable of performing power control on the transmitted PRS to transmit the PRS on the sidelink with an appropriate transmission power, such that interference to uplink transmission or other sidelink transmission is reduced and the reliability of the communication system is improved.

In addition, the embodiments provide various methods for acquiring the sidelink path loss, which improve the diversity and flexibility of the SL terminal for acquiring the PRS transmission power, and meet the requirements of the SL terminal for performing power control on the transmitted PRS in more scenarios.

In addition, in the embodiments related to the method for controlling power described above, the RSRP measured for the second signal or the third signal and the transmission powers for the second signal or the third signal are high-layer filtered RSRPs and transmission powers (exemplarily, layer 3 (L3)-filtered RSRPs and transmission powers).

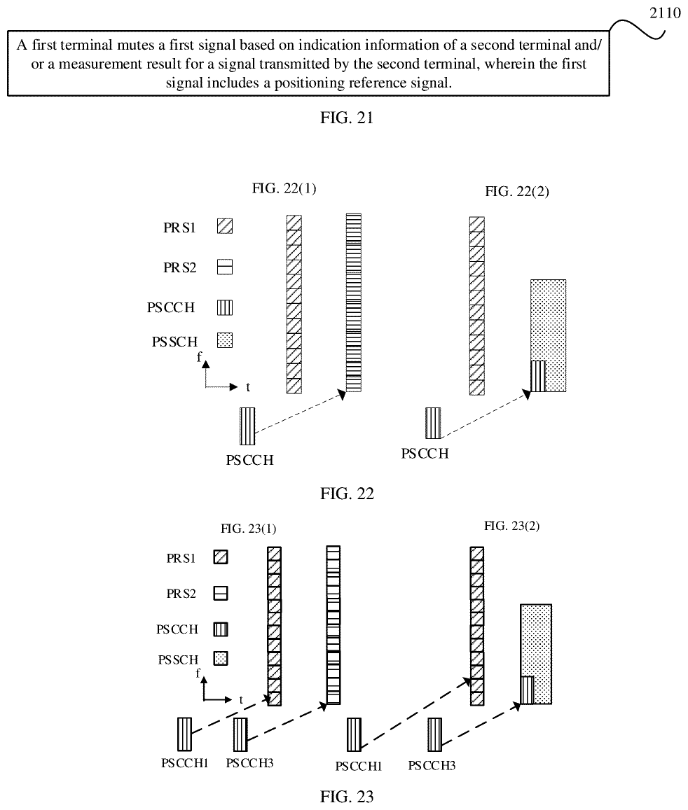

FIG. 21 is a flowchart of a method for muting transmission according to some embodiments of the present disclosure. The method is applicable to a first terminal. The method includes the following process 2110.

In process 2110, the first terminal mutes a first signal based on the indication information of a second terminal and/or the measurement result for a signal transmitted by the second terminal, wherein the first signal includes a positioning reference signal.

In some embodiments, the positioning reference signal is a sidelink positioning reference signal. That is, the first signal includes a sidelink positioning reference signal.

In some embodiments, the first terminal is different from the second terminal, and transmission between the first terminal and the second terminal is performed over a sidelink. The first terminal is a terminal device that transmits the first signal, that is, the first terminal transmits the first signal to the second terminal over the sidelink. The second terminal is a terminal device that receives or detects the first signal, that is, the second terminal receives or detects the first signal transmitted by the first terminal over the sidelink.

In some embodiments, the second terminal is any one terminal except the first terminal.

In some embodiments, the above process 2110 includes: muting, by the first terminal, the first signal based on resource reservation information and/or priority information in the sidelink control information transmitted by the second terminal, wherein the resource reservation information is defined to indicate or reserve the transmission resource for a fourth signal, and the priority information is defined to indicate the priority of the fourth signal. In some embodiments, the resource reservation information is also referred to as resource indication information.

In some embodiments, the fourth signal includes at least one of: a positioning reference signal, a signal corresponding to a PSCCH, or a signal corresponding to a PSSCH.

In some embodiments, the process that the first terminal mutes the first signal based on the resource reservation information and/or the priority information in the sidelink control information transmitted by the second terminal includes the following cases.

Case 1: In the case that the transmission resources for the fourth signal and the first signal overlap, the first terminal mutes the first signal.

Case 2: In the case that the transmission resources for the fourth signal and the first signal overlap, and the measurement result for a PSCCH for carrying the sidelink control information or the measurement result for a PSSCH or a positioning reference signal corresponding to the PSCCH of the first terminal is greater than or equal to a threshold value, the first terminal mutes the first signal.

Case 3: In the case that the transmission resources for the fourth signal and the first signal overlap and the priority indicated by the priority information is higher than the priority of the first signal and/or higher than a priority threshold, the first terminal mutes the first signal.

Case 4: In the case that the transmission resources for the fourth signal and the first signal overlap, the priority indicated by the priority information is higher than the priority of the first signal and/or higher than a priority threshold, and the measurement result for a PSCCH for carrying the sidelink control information or the measurement result for a PSSCH or a positioning reference signal corresponding to the PSCCH of the first terminal is greater than a threshold value, the first terminal mutes the first signal.

In some embodiments, the PSSCH or the positioning reference signal corresponding to the PSCCH herein is a PSSCH or a positioning reference signal scheduled or indicated by the PSCCH. For similar descriptions that occur elsewhere herein, reference may be made to this explanation.

In addition, the priority described above may be represented in value; a larger priority value represents a higher priority, or a smaller priority value represents a higher priority, which is not limited in the present disclosure.

In some embodiments, the threshold value described above is configured by the network, pre-configured, specified as a predefined value in a standard, or dependent on the implementation of the first terminal.

In some embodiments, the priority threshold described above is configured by the network, pre-configured, specified as a predefined value in a standard, or dependent on the implementation of the first terminal.

As illustrated in FIG. 22(1), the first terminal transmits a PRS1, the transmission resource for the PRS1 is the resource marked by diagonal hatching, and the first terminal monitors that the second terminal indicates the transmission resource for a PRS2 of the second terminal, i.e., the resource marked by cross hatching, using the first sidelink control information in the PSCCH.

In some embodiments, in the case that the time-frequency resources for the PRS1 and the PRS2 overlap, the first terminal mutes the PRS1, i.e., does not transmit the PRS1.

In some embodiments, in the case that the time-frequency resources for the PRS1 and the PRS2 overlap, and the RSRP of the monitored PSCCH or the RSRP of a PRS corresponding to the PSCCH measured by the first terminal is higher than an RSRP threshold, the first terminal mutes the PRS1, i.e., does not transmit the PRS1. The RSRP threshold is configured by the network, pre-configured, specified as a predefined value in a standard, or dependent on the implementation of the first terminal.

In some embodiments, in the case that the time-frequency resources for the PRS1 and the PRS2 overlap, and the priority indicated in the first sidelink control information is higher than the priority of transmitting the PRS1 and/or higher than a priority threshold, the first terminal mutes the PRS1, i.e., does not transmit the PRS1. The priority threshold is configured by the network, pre-configured, specified as a predefined value in a standard, or dependent on the implementation of the first terminal.

In some embodiments, in the case that the time-frequency resources for the PRS1 and the PRS2 overlap, the priority indicated in the first sidelink control information is higher than the priority of transmitting the PRS1 and/or higher than a priority threshold, and the RSRP of the monitored PSCCH or the RSRP of a PRS corresponding to the PSCCH measured by the first terminal is higher than an RSRP threshold, the first terminal mutes the PRS1, i.e., does not transmit the PRS1. The priority threshold is configured by the network, pre-configured, specified as a predefined value in a standard, or dependent on the implementation of the first terminal.

As illustrated in FIG. 22(2), the first terminal transmits a PRS1, the transmission resource for the PRS1 is the resource marked by diagonal hatching, and the first terminal monitors that the second terminal indicates the transmission resources for PSCCH and PSSCH of the second terminal using the first sidelink control information in the PSCCH.

In some embodiments, in the case that the time-frequency resources for the PRS1 and the PSCCH and PSSCH overlap, the first terminal mutes the PRS1, i.e., does not transmit the PRS1.

In some embodiments, in the case that the time-frequency resources for the PRS1 and the PSCCH and PSSCH overlap, and the RSRP of the monitored PSCCH or the RSRP of a PSSCH corresponding to the PSCCH measured by the first terminal is higher than an RSRP threshold, the first terminal mutes the PRS1, i.e., does not transmit the PRS1. The RSRP threshold is configured by the network, pre-configured, specified as a predefined value in a standard, or dependent on the implementation of the first terminal.

In some embodiments, in the case that the time-frequency resources for the PRS1 and the PSCCH and PSSCH overlap, and the priority indicated in the first sidelink control information is higher than the priority of transmitting the PRS1 and/or higher than a priority threshold, the first terminal mutes the PRS1, i.e., does not transmit the PRS1. The priority threshold is configured by the network, pre-configured, specified as a predefined value in a standard, or dependent on the implementation of the first terminal.

In some embodiments, in the case that the time-frequency resources for the PRS1 and the PSCCH and PSSCH overlap, the priority indicated in the first sidelink control information is higher than the priority of transmitting the PRS1 and/or higher than a priority threshold, and the RSRP of the monitored PSCCH or the RSRP of a PSSCH corresponding to the PSCCH measured by the first terminal is higher than an RSRP threshold, the first terminal mutes the PRS1, i.e., does not transmit the PRS1. The priority threshold is configured by the network, pre-configured, specified as a predefined value in a standard, or dependent on the implementation of the first terminal.

In some embodiments, in the case that the transmission resource for the first terminal to transmit the first signal and the transmission resource for the third terminal to transmit a fifth signal satisfy a conflict condition, the second terminal transmits the indication information to the first terminal, and the first terminal mutes the first signal based on the indication information. In some embodiments, determining whether the transmission resource for the first terminal to transmit the the first signal and the transmission resource for the third terminal to transmit the fifth signal satisfy the conflict condition is performed by the second terminal.

In some embodiments, the indication information includes at least one of: a signal carried over the PSCCH, a signal carried over the PSSCH, MAC CE signaling, RRC signaling, or a signal carried over the PSFCH.

In some embodiments, the conflict condition includes at least one of the following items:
the transmission resource for the first terminal to transmit the first signal and the transmission resource for the third terminal to transmit the fifth signal overlap; or
the signal of the first terminal and/or the signal of the third terminal satisfies a signal quality threshold condition.

In some embodiments, the conflict condition further includes the priority for transmitting the first signal by the first terminal being lower than the priority for transmitting the fifth signal by the third terminal.

In some embodiments, the fifth signal includes at least one of: a positioning reference signal, a signal corresponding to the PSCCH, or a signal corresponding to the PSSCH.

In some embodiments, the signal of the first terminal and/or the signal of the third terminal satisfying the signal quality threshold condition includes any one of the following items:

the measurement result for the PSCCH transmitted by the third terminal or for a PSSCH or a positioning reference signal corresponding to the PSCCH transmitted by the third terminal is less than or equal to a first threshold;

the measurement result for the PSCCH transmitted by the first terminal or for a PSSCH or a positioning reference signal corresponding to the PSCCH transmitted by the first terminal is greater than or equal to a second threshold; or

the difference value between the measurement result for the PSCCH transmitted by the first terminal or for a PSSCH or a positioning reference signal corresponding to the PSCCH transmitted by the first terminal and the measurement result for the PSCCH transmitted by the third terminal or for a PSSCH or a positioning reference signal corresponding to the PSCCH transmitted by the third terminal is greater than or equal to a third threshold. In some embodiments, the difference value between the measurement result for the PSCCH transmitted by the first terminal or for a PSSCH or a positioning reference signal corresponding to the PSCCH transmitted by the first terminal and the measurement result for the PSCCH transmitted by the third terminal or for a PSSCH or a positioning reference signal corresponding to the PSCCH transmitted by the third terminal is greater than the third threshold. Exemplarily, the difference value between the measurement result for the PSCCH transmitted by the first terminal and the measurement result for the PSCCH transmitted by the third terminal is greater than or equal to the third threshold. Exemplarily, the difference value between the measurement result for the PSCCH transmitted by the first terminal and the measurement result for the PSCCH transmitted by the third terminal is greater than the third threshold.

Exemplarily, the difference value between the measurement result for the positioning reference signal corresponding to the PSCCH transmitted by the first terminal and the measurement result for the positioning reference signal corresponding to the PSCCH transmitted by the third terminal is greater than or equal to the third threshold. Exemplarily, the difference value between the measurement result for the positioning reference signal corresponding to the PSCCH transmitted by the first terminal and the measurement result for the positioning reference signal corresponding to the PSCCH transmitted by the third terminal is greater than the third threshold.

Exemplarily, the difference value between the measurement result for the PSSCH corresponding to the PSCCH transmitted by the first terminal and the measurement result for the PSSCH corresponding to the PSCCH transmitted by the third terminal is greater than or equal to the third threshold. Exemplarily, the difference value between the measurement result for the PSSCH corresponding to the PSCCH transmitted by the first terminal and the measurement result for the PSSCH corresponding to the PSCCH transmitted by the third terminal is greater than the third threshold.

The above manner for calculating the difference value is only exemplary and illustrative, which is not limited in the present disclosure, and other manners for calculating the difference value may also be adopted. For example, the difference value between the measurement result for the PSCCH transmitted by the first terminal and the measurement result for the PSSCH or the positioning reference signal corresponding to the PSCCH transmitted by the third terminal is greater than the third threshold.

In some embodiments, at least one of the first threshold, the second threshold, or the third threshold described above is configured by the network, pre-configured, specified as a predefined value in a standard, or dependent on the implementation of the first terminal.

Exemplarily, as illustrated in FIG. 23(1), the PRS1 is the PRS signal of the first terminal, the transmission resource for the PRS1 is the resource marked by diagonal hatching, and the first terminal transmits a PSCCH1 to indicate or reserve the time-frequency resource for the PRS1. The PRS2 is the PRS signal of the third terminal, the transmission resource for the PRS2 is the resource marked by cross hatching, and the third terminal transmits a PSCCH3 to indicate or reserve the time-frequency resource for the PRS2. The second terminal monitors the first sidelink control information in the PSCCH1 and the PSCCH3, and knows the time-frequency resource positions of the PRS1 and the PRS2.

In some embodiments, in the case that the time-frequency resources for the PRS1 and the PRS2 overlap, the second terminal transmits indication information to the first terminal.

In some embodiments, in the case that the time-frequency resources for the PRS1 and the PRS2 overlap, and the RSRP of the PSCCH3 or the RSRP of a PRS scheduled by the PSCCH3 measured by the second terminal is less than an RSRP threshold, the second terminal transmits indication information to the first terminal.

In some embodiments, in the case that the time-frequency resources for the PRS1 and the PRS2 overlap, and the RSRP of the PSCCH1 or the RSRP of a PRS scheduled by the PSCCH1 measured by the second terminal is higher than an RSRP threshold, the second terminal transmits indication information to the first terminal.

In some embodiments, in the case that the time-frequency resources for the PRS1 and the PRS2 overlap, and the difference between the RSRP of the PSCCH1 or the RSRP of a PRS scheduled by the PSCCH1 measured by the second terminal and the RSRP of the PSCCH3 or the RSRP of a PRS scheduled by the PSCCH3 measured by the second terminal is greater than an RSRP threshold, the second terminal transmits indication information to the first terminal.

In the case that the first terminal receives the indication information from the second terminal, the first terminal mutes the transmission of the PRS1. The indication information may be transmitted using one or more of the PSCCH, PSSCH, MAC CE, PC5-RRC signaling, or PSFCH.

In some embodiments, in the case that the priority indicated by the sidelink control information in the PSCCH1 is lower than the priority indicated in the PSCCH3, the second terminal transmits indication information to the first terminal only in the case that the above conditions are satisfied.

Exemplarily, as illustrated in FIG. 23(2), the PRS1 is the PRS signal of the first terminal, the transmission resource for the PRS1 is the resource marked by diagonal hatching, and the first terminal transmits a PSCCH1 to indicate or reserve the time-frequency resource for the PRS1. The transmission resources for the PSCCH and the PSSCH in the figure are the transmission resources for the third terminal. The transmission resources (denoted as the transmission resource 1) are the resources marked by vertical hatching and dot hatching, and the third terminal transmits the PSCCH3 to indicate or reserve the transmission resource 1. The second terminal monitors the first sidelink control information in the PSCCH1 and the PSCCH3, and knows the time-frequency resource positions of the PRS1 and the transmission resource 1.

In some embodiments, in the case that the time-frequency resources for the PRS1 and the transmission resource 1 overlap, the second terminal transmits indication information to the first terminal.

In some embodiments, in the case that the time-frequency resources for the PRS1 and the transmission resource 1 overlap, and the RSRP of the PSCCH3 or the RSRP of a PSSCH scheduled by the PSCCH3 measured by the second terminal is less than an RSRP threshold, the second terminal transmits indication information to the first terminal.

In some embodiments, in the case that the time-frequency resources for the PRS1 and the transmission resource 1 overlap, and the RSRP of the PSCCH1 or the RSRP of a PRS scheduled by the PSCCH1 measured by the second terminal is higher than an RSRP threshold, the second terminal transmits indication information to the first terminal.

In some embodiments, in the case that the time-frequency resources for the PRS1 and the transmission resource 1 overlap, and the difference between the RSRP of the PSCCH1 or the RSRP of a PRS scheduled by the PSCCH1 measured by the second terminal and the RSRP of the PSCCH3 or the RSRP of a PSSCH scheduled by the PSCCH3 measured by the second terminal is greater than an RSRP threshold, the second terminal transmits indication information to the first terminal.

In the case that the first terminal receives the indication information from the second terminal, the first terminal mutes the transmission of the PRS1. The indication information may be transmitted using one or more of the PSCCH, PSSCH, MAC CE, PC5-RRC signaling, or PSFCH.

In some embodiments, in the case that the priority indicated by the sidelink control information in the PSCCH1 is lower than the priority indicated in the PSCCH3, the second terminal transmits indication information to the first terminal only in the case that the above conditions are satisfied.

In the technical solutions according to the embodiments, the first terminal mutes the first signal including a PRS based on the indication information of the second terminal and/or the measurement result for the signal transmitted by the second terminal. In this way, the SL terminal is capable of muting the PRS on the sidelink at some suitable occasions, such that interference to uplink transmission or other sidelink transmission is reduced and the reliability of the communication system is improved.

In addition, the embodiments provide various determination conditions for muting the PRS, such that the SL terminal is capable of making a more accurate decision on muting the PRS on the sidelink.

It should be noted that the method for controlling power and/or the method for muting transmission according to the present disclosure is also applicable to power control and/or transmission muting of an SL PRS transmitted by an RSU. That is, the first terminal may be an RSU. Exemplarily, the RSU refers to a UE-type RSU.

The following are the apparatus embodiments of the present disclosure that may be configured to implement the method embodiments of the present disclosure. For details that are not disclosed in the apparatus embodiments of the present disclosure, reference is made to the method embodiments of the present disclosure.

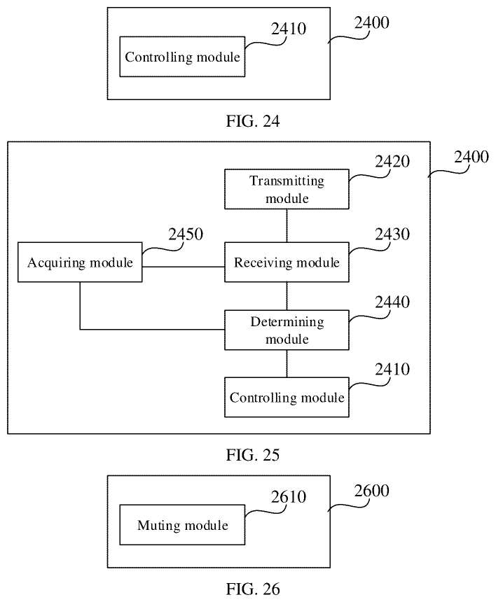

FIG. 24 is a block diagram of an apparatus for controlling power according to some embodiments of the present disclosure. The apparatus has functions for implementing the example method for controlling power described above, and the functions may be implemented by hardware or by executing corresponding software on hardware. The apparatus may be the terminal device (e.g. the first terminal) described above, or may be disposed in the terminal device (e.g. the first terminal). As illustrated in FIG. 24, the apparatus 2400 may include a controlling module 2410.

The controlling module 2400 is configured to perform power control on a first signal based on a sidelink path loss and/or a target communication distance, wherein the first signal includes a positioning reference signal, and the sidelink path loss refers to a transmission loss on a sidelink between the first terminal and the second terminal.

In some embodiments, the sidelink path loss is determined based on a first transmission power and a first measurement result, wherein the first transmission power is a transmission power for transmitting a second signal by the first terminal to the second terminal over the sidelink, and the first measurement result is the measurement result of the second terminal for the second signal.

In some embodiments, as illustrated in FIG. 25, the apparatus 2400 further includes: a transmitting module 2420, a receiving module 2430, and a determining module 2440.

The transmitting module 2420 is configured to transmit the second signal to the second terminal over the sidelink.

The receiving module 2430 is configured to receive the first measurement result.

The determining module 2440 is configured to determine the sidelink path loss based on the first transmission power and the first measurement result.

In some embodiments, a plurality of second terminals are deployed, and the first transmitting module is further configured to transmit the second signal to the plurality of second terminals by the first terminal.

The determining module 2440 is configured to determine a first measurement result with the worst signal quality from first measurement results respectively corresponding to the plurality of second terminals, and determine the sidelink path loss based on the first transmission power and the first measurement result with the worst signal quality; or to determine a plurality of sidelink path losses based on the first transmission power and first measurement results respectively corresponding to the plurality of second terminals, and select the maximum value among the plurality of sidelink path losses as the sidelink path loss for performing power control on the first signal.

In some embodiments, the second signal includes at least one of the following: RRC signaling, MAC CE signaling, a signal carried over a PSCCH, a signal carried over a PSSCH, or a positioning reference signal.

In some embodiments, the function of the second signal includes at least one of:
transmitting a positioning capability request, or transmitting a positioning capability;
transmitting an assistance information request, or transmitting assistance information;
transmitting a position information request, transmitting position information, or transmitting a position calculation result; or
transmitting a positioning reference signal.

In some embodiments, the sidelink path loss is determined based on a second transmission power and a second measurement result, wherein the second transmission power is a transmission power for transmitting a third signal by the second terminal to the first terminal over the sidelink, and the second measurement result is the measurement result of the first terminal for the third signal.

In some embodiments, as illustrated in FIG. 25, the apparatus 2400 further includes: a receiving module 2430, an acquiring module 2450, and a determining module 2440.

The receiving module 2430 is configured to receive the third signal transmitted by the second terminal over the sidelink.

The acquiring module 2450 is configured to acquire the second transmission power and the second measurement result.

The determining module 2440 is configured to determine the sidelink path loss based on the second transmission power and the second measurement result.

In some embodiments, there are a plurality of second terminals, and the plurality of second terminals separately transmit the third signal to the first terminal and indicate respective second transmission powers. The determining module 2440 is configured to determine sidelink path losses respectively corresponding to the plurality of second terminals based on the second transmission powers and second measurement results respectively corresponding to the plurality of second terminals; and select a maximum value among the sidelink path losses respectively corresponding to the plurality of second terminals as the sidelink path loss for performing power control on the first signal.

In some embodiments, the third signal includes at least one of: RRC signaling, MAC CE signaling, a signal carried over a PSCCH, a signal carried over a PSSCH, or a positioning reference signal.

In some embodiments, the function of the third signal includes at least one of:
transmitting a positioning capability request, or transmitting a positioning capability;
transmitting an assistance information request, or transmitting assistance information;
transmitting a position information request, transmitting position information, or transmitting a position calculation result; or
transmitting a positioning reference signal.

In some embodiments, the second transmission power is indicated in sidelink control information associated with the third signal.

In some embodiments, the target communication distance is configured by a network, pre-configured, specified as a predefined value in a standard, or dependent on the implementation of the first terminal.

In some embodiments, the target communication distance is related to at least one of the following: positioning accuracy, a positioning algorithm, a positioning calculation capability, the priority of the first signal, or time-domain configuration parameters of the first signal.

In some embodiments, the controlling module 2410 is configured to determine, based on the corresponding relationship between the communication distance and the transmission power, the transmission power for the first signal according to a transmission power corresponding to the target communication distance.

In some embodiments, in the case that the positioning reference signal and a signal corresponding to the PSCCH are mapped on the frequency-domain resources corresponding to the same time unit, the transmission power for the positioning reference signal and the transmission power for the signal corresponding to the PSCCH are allocated based on the ratio of the frequency-domain resources occupied.

In some embodiments, the positioning reference signal is a sidelink positioning reference signal.

In some embodiments, the first terminal is an anchor terminal or an RSU, and the second terminal is a terminal performing positioning based on the positioning reference signal; or, the first terminal is a terminal performing positioning based on the positioning reference signal, and the second terminal is an anchor terminal or an RSU.

FIG. 26 is a block diagram of an apparatus for muting transmission according to some embodiments of the present disclosure. The apparatus has functions for implementing the example method for muting transmission described above, and the functions can be implemented by hardware or by executing corresponding software on hardware. The apparatus may be the terminal device (e.g. the first terminal) described above, or may be disposed in the terminal device (e.g. the first terminal). As illustrated in FIG. 26, the apparatus 2600 may include a muting module 2610.

The muting module 2610 is configured to mute a first signal based on the indication information of a second terminal and/or the measurement result for a signal transmitted by the second terminal, wherein the first signal includes a positioning reference signal.

In some embodiments, the second terminal is a terminal that receives or detects the first signal.

In some embodiments, the second terminal is any one terminal except the first terminal.

In some embodiments, the muting module 2610 is configured to mute the first signal based on resource reservation information and/or priority information in the sidelink control information transmitted by the second terminal, wherein the resource reservation information is defined to indicate or reserve the transmission resource for a fourth signal, and the priority information is defined to indicate the priority of the fourth signal.

In some embodiments, the muting module 2610 is configured to mute the first signal in the case that the transmission resources for the fourth signal and the first signal overlap.

Alternatively, the muting module is configured to mute the first signal in the case that the transmission resources for the fourth signal and the first signal overlap, and the measurement result for a PSCCH for carrying the sidelink control information or the measurement result for a PSSCH or a positioning reference signal corresponding to the PSCCH of the first terminal is greater than or equal to a threshold value.

Alternatively, the muting module is configured to mute the first signal in the case that the transmission resources for the fourth signal and the first signal overlap, and the priority indicated by the priority information is higher than the priority of the first signal and/or higher than a priority threshold.

Alternatively, the muting module is configured to mute the first signal in the case that the transmission resources for the fourth signal and the first signal overlap, the priority indicated by the priority information is higher than the priority of the first signal and/or higher than a priority threshold, and the measurement result for a PSCCH for carrying the sidelink control information or the measurement result for a PSSCH or a positioning reference signal corresponding to the PSCCH of the first terminal is greater than a threshold value.

In some embodiments, the fourth signal includes at least one of: a positioning reference signal, a signal corresponding to the PSCCH, or a signal corresponding to the PSSCH.

In some embodiments, in the case that a transmission resource for the first terminal to transmit the first signal and a transmission resource for a third terminal to transmit a fifth signal satisfy a conflict condition, the second terminal transmits the indication information to the first terminal, and the first terminal mutes the first signal based on the indication information.

In some embodiments, the conflict condition includes at least one of the following items:
The transmission resource for the first terminal to transmit the first signal is overlapped with the transmission resource for the third terminal to transmit the fifth signal; or
the signal of the first terminal and/or the signal of the third terminal satisfies a signal quality threshold condition.

In some embodiments, the signal of the first terminal and/or the signal of the third terminal satisfying the signal quality threshold condition, includes any one of the following items:
The measurement result for the PSCCH transmitted by the third terminal or for a PSSCH or a positioning reference signal corresponding to the PSCCH transmitted by the third terminal is less than or equal to a first threshold;
the measurement result for the PSCCH transmitted by the first terminal or for a PSSCH or a positioning reference signal corresponding to the PSCCH transmitted by the first terminal is greater than or equal to a second threshold; or
the difference value between the measurement result for the PSCCH transmitted by the first terminal or for a PSSCH or a positioning reference signal corresponding to the PSCCH transmitted by the first terminal and the measurement result for the PSCCH transmitted by the third terminal or for a PSSCH or a positioning reference signal corresponding to the PSCCH transmitted by the third terminal is greater than or equal to a third threshold.

In some embodiments, the conflict condition further includes the priority for transmitting the first signal by the first terminal being lower than the priority for transmitting the fifth signal by the third terminal.

In some embodiments, the fifth signal includes at least one of the following: a positioning reference signal, a signal corresponding to the PSCCH, or a signal corresponding to the PSSCH.

In some embodiments, the positioning reference signal is a sidelink positioning reference signal.

It should be noted that, in the case that the apparatus according to the above embodiments implements the functions thereof, the division of the functional modules is merely exemplary. In practical application, the above functions may be assigned to different functional modules according to actual needs, i.e., the internal structure of the device may be divided into different functional modules, so as to implement all or a part of the above functions.

With regard to the apparatus in the above embodiments, the specific mode in which each module performs the operation has been described in detail in the embodiments related to the method and is not be described in detail herein. Reference is made to the above method embodiments for details that are not specified in the apparatus embodiments.

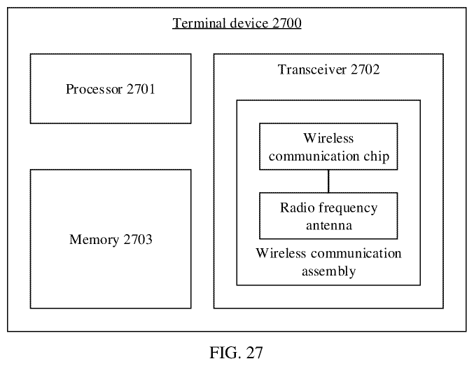

FIG. 27 is a schematic structural diagram of a terminal device according to some embodiments of the present disclosure. The terminal device 2700 includes: a processor 2701, a transceiver 2702, and a memory 2703.

The processor 2701 includes one or more processing cores, and the processor 2701 runs various functional applications and performs information processing by running one or more software programs and modules.

The transceiver 2702 includes a receiver and a transmitter, which are implemented, for example, as the same wireless communication assembly that includes a wireless communication chip and a radio frequency antenna.

The memory 2703 may be connected to the processor 2701 and the transceiver 2702.

The memory 2703 may be configured to store one or more computer programs loaded and run by the processor, and the processor 2701 is configured to load and run the one or more computer programs to perform the processes in the above method embodiments.

In some embodiments, the processor 2701 is configured to perform power control on a first signal including a positioning reference signal based on a sidelink path loss and/or a target communication distance, wherein the sidelink path loss refers to a transmission loss on a sidelink between a first terminal and a second terminal.

In some embodiments, the processor 2701 is configured to mute a first signal including a positioning reference signal based on the indication information of a second terminal and/or the measurement result for a signal transmitted by the second terminal.

For details that are not specified in the embodiments, reference may be made to the embodiments described above, and the details are not described herein any further.

In addition, the memory may be practiced by any type of volatile or non-volatile storage device or a combination thereof. The volatile or non-volatile storage device includes but is not limited to: a magnetic disk or an optical disc, an electrically erasable programmable read-only memory (EEPROM), an erasable programmable read-only memory (EPROM), a static random-access memory (SRAM), a read-only memory (ROM), a magnetic memory, a flash memory, or a programmable read-only memory (PROM).

The embodiments of the present disclosure further provide a computer-readable storage medium storing one or more computer programs therein. The one or more computer programs, when loaded and run by a processor, cause the processor to perform the method for controlling power or the method for muting transmission described above. In some embodiments, the computer-readable storage medium includes: a ROM, a random-access memory (RAM), a solid state drive (SSD), an optical disk, or the like. The RAM includes a resistance random-access memory (ReRAM) and a dynamic random-access memory (DRAM).

The embodiments of the present disclosure further provide a chip including one or more programmable logic circuits and/or one or more program instructions. The chip, when running, is caused to perform the method for controlling power or the method for muting transmission described above.

The embodiments of the present disclosure further provide a computer program product. The computer program product including one or more computer instructions stored in a computer-readable storage medium. The one or more computer instructions, when read from the computer-readable storage medium, and loaded and executed by a processor, cause the processor to perform the method for controlling power or the method for muting transmission described above.

It should be understood that the term “indication” mentioned in the embodiments of the present disclosure is a direct indication, an indirect indication, or an indication that an association relationship is present. For example, “A indicates B” may mean that A indicates B directly, e.g., B may be acquired through A; or that A indicates B indirectly, e.g., A indicates C through which B may be acquired; or that an association relationship is present between A and B.

In the description of the embodiments of the present disclosure, the term “correspond” indicates a direct or indirect corresponding relationship between two items, or indicates an association relationship between the two items. It may also indicate relationships such as indicating and being indicated, and configuring and being configured.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, the term “predefined” refers to “defined” in a protocol.

In some embodiments of the present disclosure, the term “protocol” refers to a standard protocol in the field of communication, for example, the LTE protocol, the NR protocol, and related protocols appliable to future communication systems, which is not limited in the present disclosure.

The mentioned term “a plurality of” herein means two or more. The term “and/or” describes the association relationship between the associated objects and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the processes described herein only show an exemplary possible execution sequence among the processes, and in some embodiments, the processes may also be executed out of the numbering sequence, for example, two processes with different serial numbers are executed simultaneously, or two processes with different serial numbers are executed in a reverse order to the illustrated sequence, which is not limited in the present disclosure.

Those skilled in the art should recognize that in the one or more examples described above, the functions described in the embodiments of the present disclosure may be implemented using hardware, software, firmware, or any combination thereof. The functions, when implemented by software, are stored in a computer-readable medium or transmitted as one or more instructions or codes on the computer-readable medium. The computer-readable medium includes a computer storage medium and a communication medium. The communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for controlling power, applicable to a first terminal, the method comprising:
performing power control on a first signal based on a sidelink path loss and/or a target communication distance, wherein the first signal comprises a positioning reference signal, and the sidelink path loss refers to a transmission loss on a sidelink between the first terminal and a second terminal.

2. The method according to claim 1, wherein the sidelink path loss is determined based on a first transmission power and a first measurement result, wherein the first transmission power is a transmission power for transmitting a second signal by the first terminal to the second terminal over the sidelink, and the first measurement result is a measurement result of the second terminal for the second signal.

3. The method according to claim 2, further comprising:
transmitting the second signal to the second terminal over the sidelink;
receiving the first measurement result; and
determining the sidelink path loss based on the first transmission power and the first measurement result.

4. The method according to claim 2, wherein the second signal comprises at least one of: radio resource control (RRC) signaling, medium access control (MAC) control element (CE) signaling, a signal carried over a physical sidelink control channel (PSCCH), a signal carried over a physical sidelink shared channel (PSSCH), or a positioning reference signal.

5. The method according to claim 2, wherein a function of the second signal comprises at least one of:
transmitting a positioning capability request, or transmitting a positioning capability;
transmitting an assistance information request, or transmitting assistance information;
transmitting a position information request, transmitting position information, or transmitting a position calculation result; or
transmitting a positioning reference signal.

6. The method according to claim 1, wherein the positioning reference signal is a sidelink positioning reference signal.

7. The method according to claim 1, wherein
the first terminal is an anchor terminal or a road side unit (RSU), and the second terminal is a terminal performing positioning based on the positioning reference signal; or
the first terminal is a terminal performing positioning based on the positioning reference signal, and the second terminal is an anchor terminal or an RSU.

8. A terminal device, comprising: a processor and a memory, wherein the memory is configured to store one or more computer programs therein, wherein the processor is configured to load and run the one or more computer programs, to cause the terminal device to:
perform power control on a first signal based on a sidelink path loss and/or a target communication distance, wherein the first signal comprises a positioning reference signal, and the sidelink path loss refers to a transmission loss on a sidelink between a first terminal and a second terminal.

9. The terminal device according to claim 8, wherein the sidelink path loss is determined based on a first transmission power and a first measurement result, wherein the first transmission power is a transmission power for transmitting a second signal by the first terminal to the second terminal over the sidelink, and the first measurement result is a measurement result of the second terminal for the second signal.

10. The terminal device according to claim 9, wherein the processor is configured to load and run the one or more computer programs, to cause the terminal device further to:
transmit the second signal to the second terminal over the sidelink;
receive the first measurement result; and
determine the sidelink path loss based on the first transmission power and the first measurement result.

11. The terminal device according to claim 9, wherein the second signal comprises at least one of the following: radio resource control (RRC) signaling, medium access control (MAC) control element (CE) signaling, a signal carried over a physical sidelink control channel (PSCCH), a signal carried over a physical sidelink shared channel (PSSCH), or a positioning reference signal.

12. The terminal device according to claim 9, wherein a function of the second signal comprises at least one of:
transmitting a positioning capability request, or transmitting a positioning capability;
transmitting an assistance information request, or transmitting assistance information;
transmitting a position information request, transmitting position information, or transmitting a position calculation result; or
transmitting a positioning reference signal.

13. The terminal device according to claim 8, wherein the positioning reference signal is a sidelink positioning reference signal.

14. The terminal device according to claim 8, wherein
the first terminal is an anchor terminal or a road side unit (RSU), and the second terminal is a terminal performing positioning based on the positioning reference signal; or
the first terminal is a terminal performing positioning based on the positioning reference signal, and the second terminal is an anchor terminal or an RSU.

15. A chip, comprising: one or more programmable logic circuits and/or one or more program instructions, wherein the chip, when running, is caused to:
perform power control on a first signal based on a sidelink path loss and/or a target communication distance, wherein the first signal comprises a positioning reference signal, and the sidelink path loss refers to a transmission loss on a sidelink between a first terminal and a second terminal.

16. The chip according to claim 15, wherein the sidelink path loss is determined based on a first transmission power and a first measurement result, wherein the first transmission power is a transmission power for transmitting a second signal by the first terminal to the second terminal over the sidelink, and the first measurement result is a measurement result of the second terminal for the second signal.

17. The chip according to claim 16, wherein the chip, when running, is further caused to:
transmit the second signal to the second terminal over the sidelink;
receive the first measurement result; and
determine the sidelink path loss based on the first transmission power and the first measurement result.

18. The chip according to claim 16, wherein the second signal comprises at least one of the following: radio resource control (RRC) signaling, medium access control (MAC) control element (CE) signaling, a signal carried over a physical sidelink control channel (PSCCH), a signal carried over a physical sidelink shared channel (PSSCH), or a positioning reference signal.

19. The chip according to claim 16, wherein a function of the second signal comprises at least one of:
transmitting a positioning capability request, or transmitting a positioning capability;
transmitting an assistance information request, or transmitting assistance information;
transmitting a position information request, transmitting position information, or transmitting a position calculation result; or
transmitting a positioning reference signal.

20. The chip according to claim 15, wherein the positioning reference signal is a sidelink positioning reference signal.
